(19) United States
(12) Patent Application Publication
(10) Pub. No.: US 2026/0284750 A1
(43) Pub. Date: Sep. 24, 2026

(54) 3D PRINTING SYSTEM UTILIZING A MULTI-MATERIAL PRINTING UNIT

(71) Applicant: studio 3e8, Inc., Somerville, MA (US)

(72) Inventors: Casey Johnson, Somerville, MA (US); Cassandra E. Lowell, Somerville, MA (US)

(21) Appl. No.: 19/088,715

(22) Filed: Mar. 24, 2025

(51) Int. Cl. B22F 12/55; B22F 10/43; B22F 12/17; B33Y 10/00; B33Y 30/00

(52) U.S. Cl. CPC B22F 12/55; B22F 10/43; B22F 12/17; B33Y 10/00; B33Y 30/00

(57) ABSTRACT

A three-dimensional (3D) printing system includes (i) a printing unit, (ii) a crucible, (iii) a furnace, and (iv) a computing system. The printing unit is adapted to hold, move, and actuate at least (i) a first nozzle that is connected via a first feed line to a first material canister containing a first type of material from which a 3D object is to be created and (ii) a second nozzle that is connected via a second feed line to a second material canister containing a second type of material that is to serve as a scaffold for the first type of material during creation of the 3D object. The computing system is programmed to carry out functions comprising: (i) controlling the printing unit to dispense materials from the first and second nozzles into the crucible and (ii) controlling the furnace to heat the crucible.

### BACKGROUND

Three-dimensional (“3D”) objects, in a physical space, may be created in various ways using a variety of machines and/or processes. An entity (e.g., an individual or an organization) that wishes to create 3D objects in the physical space may determine which machines and/or processes to use, based on a scale of production at which the entity wishes to produce the objects (e.g., the scale of production is for mass production, the scale of production is a prototype in early development, among other scales of production).

For as long as mass production of 3D objects has occurred, various processes (and associated machines) have been utilized in the mass production of 3D objects (e.g., various types of casting processes, various types of machining processes, various types of molding processes, etc.). However, these legacy mass-production processes are typically only suitable when there is a desire to produce a mass quantity of identical 3D objects, because it is typically cost prohibitive to use such processes for smaller scale production of 3D objects-let alone for the creation of customized 3D objects (e.g., prototypes, custom designs, etc.) such as, for example, those that may be used in the medical industry. In addition, these legacy mass-production processes may also not be capable of creating 3D objects having certain types of geometries (e.g., geometries produced by computational design or optimization software).

To address these and other problems with legacy mass-production processes such as casting, machining, or the like, 3D printing technologies have emerged as alternative technologies for forming 3D objects. In general, 3D printing technology involves utilizing one or more electro-mechanical components as tools to create a 3D object, wherein the electro-mechanical components are configured to create the object based on a previously generated (and computer-based) 3D model for the 3D object. Advantageously, 3D printing technology can be utilized for creating objects at both a mass scale of production and at a more limited scale of production.

### SUMMARY

Disclosed herein is a new three-dimensional (3D) printing system that carries out functionality for creating 3D objects.

In one aspect, a 3D printing system may include (i) a printing unit, (ii) a crucible, (iii) a furnace, and (iv) a computing system. The printing unit may be adapted to hold, move, and actuate at least (i) a first nozzle that is connected via a first feed line to a first material canister containing a first type of material from which a 3D object is to be created and (ii) a second nozzle that is connected via a second feed line to a second material canister containing a second type of material that is to serve as a scaffold for the first type of material during creation of the 3D object. The computing system may be programmed to carry out functions comprising: (i) controlling the printing unit to dispense materials from the first and second nozzles into the crucible and (ii) controlling the furnace to heat the crucible.

The first type of material and the second type of material may take any of various forms. For example, the first type of material may comprise a metal material and the second type of material may comprise an inert material. In another example, the second type of material may have an abrasive texture that serves to polish, smooth, debur, or clean the 3D object during post-processing.

Controlling the printing unit, by the computing system, to dispense materials from the first and second nozzles into the crucible may take any of various forms. For example, controlling the printing unit may comprise controlling the printing unit to dispense materials from the first and second nozzles into the crucible on a layer-by-layer basis for a plurality of layers, wherein each respective layer of the plurality of layers comprises either or both of the first type of material or the second type of material. Further still, in some such examples, controlling the printing unit to dispense materials from the first and second nozzles into the crucible on the layer-by-layer basis for the plurality of layers comprises, for each respective layer of the plurality of layers, one or both of (i) controlling the printing unit to dispense the first type of material from the first nozzle into the crucible in accordance with a first print-path for dispensing the first type of material within the respective layer or (ii) controlling the printing unit to dispense the second type of material from the second nozzle into the crucible in accordance with a second print-path for dispensing the second type of material within the respective layer.

The printing unit may take any of various forms. For example, the printing unit may comprise (i) a carriage body, (ii) a first dispensing unit that is configured to hold and actuate the first nozzle, (iii) a second dispensing unit that is configured to hold and actuate the second nozzle, (iv) a first dispensing-motion unit that is configured to move the first dispensing unit in a vertical direction relative to the carriage body, (v) a second dispensing-motion unit that is configured to move the second dispensing unit in the vertical direction relative to the carriage body, and (vi) a carriage motion system that is configured to move the carriage in a horizontal plane. Further still, in one such example, (i) the first dispensing unit comprises a first vibrator that is configured to vibrate the first nozzle and (ii) the second dispensing unit comprises a second vibrator that is configured to vibrate the second nozzle. In yet another further example, the 3D printing system further includes (i) a third vibrator that is configured to vibrate the first material canister and (ii) a fourth vibrator that is configured to vibrate the second material canister.

Further still, in an additional or alternative example, the printing unit may be further adapted to hold, move, and actuate one or more additional nozzles that are each connected via a respective feed line to a respective material canister. In such an example, the computing system may further be programmed to carry out functions comprising along with controlling the printing unit to dispense materials from the first nozzle and the second nozzle into the crucible, controlling the printing unit to dispense one or more materials from the one or more additional nozzles into the crucible.

The first and second nozzles may each take any of various forms. For example, each of the first and second nozzles may comprise (i) an interior chamber that is fillable with the first or second type of material, (ii) a bottom orifice for releasing the first or second type of material from the interior chamber, and (iii) a valve stem that is movable within the interior chamber and operatble to open and close the bottom orifice.

The computing system may take any of various forms. For example, the computing system may comprise (i) a general-purpose computing unit and (ii) one or more specific-purpose computing units that are each communicatively coupled to the general-purpose computing unit.

The first and second nozzles, the first and second feedlines, and the first and second material cannisters may each take any of various forms. For example, (i) the first nozzle, the first feed line, and the first material canister may be bonded together and/or (ii) the second nozzle, the second feed line, and the second material canister may be bonded together.

The 3D printing system may take various forms and/or include additional or alternative components. For example, the 3D printing system may further include a camera that is operable to capture images of the crucible. In such examples, the computing system may further be programmed to carry out functions that include using the images of the crucible captured by the camera as a basis for analyzing a state of the dispensed material within the crucible.

In yet another aspect, the disclosed 3D printing system may take the form of a method for creating a 3D object that is carried out utilizing the aforementioned apparatus and functions.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### BRIEF DESCRIPTION OF THE DRAWINGS

FIG. 1 depicts a front view of an example 3D printing system, in accordance with the present disclosure.

FIG. 2A is a schematic diagram illustrating components of an example 3D printing system that illustrates functional connectivity between said components and a client device, in accordance with the present disclosure.

FIG. 2B is another schematic diagram illustrating components of an example 3D printing system that illustrates functional connectivity between said components and a client device, in accordance with the present disclosure.

FIG. 3A is a side, cross-sectional view of an example dispensing nozzle of the printing unit of FIGS. 2A and 2B, shown with a valve stem in an open position for dispensing a material.

FIG. 3B is another side, cross-sectional view of the example dispensing nozzle of the multi-material dispensing unit of FIG. 3C, shown with the valve stem in a closed position for dispensing the material.

FIG. 4A is a 3D front view of the printing unit of FIGS. 2A and 2B.

FIG. 4B is a 3D, side, perspective view of an example printing unit and crucible for use within a 3D printing system, in accordance with the present disclosure.

FIG. 5A is a first side view of a printing unit and a crucible in which the multi-material dispensing unit creates objects, at a first point in time during a process for creating an object.

FIG. 5B is a second side view of the printing dispensing unit and the crucible of FIG. 5A, at a second point in time during the process for creating the object.

FIG. 5C is a third side view of the printing unit and the crucible of FIGS. 5A, 5B, at a third point in time during the process for creating the object.

FIG. 5D is a fourth side view of the printing unit and the crucible of FIGS. 5A-C, at a fourth point in time during the process for creating the object.

FIG. 5E is a fifth side view of the printing unit and the crucible of FIGS. 5A-D, at a fifth point in time during the process for creating the object.

FIG. 6 is an example flow chart depicting 3D printing technology that may be carried out by the 3D printing system(s) disclosed herein.

FIG. 7 is a simplified block diagram illustrating some structural components that may be included in an example computing unit that may be configured to perform some or all of the system-level control functions disclosed herein.

FIG. 8 is a simplified block diagram illustrating some structural components that may be included in an example client device that may be configured to perform some or all of the client-side functions disclosed herein.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure refers to the accompanying figures and several examples. One of ordinary skill in the art would understand that such references are for the purpose of explanation only and are therefore not meant to be limiting. Part or all of the disclosed systems, devices, and methods may be rearranged, combined, added to, and/or removed in a variety of manners, each of which is contemplated herein.

As noted above, three-dimensional (3D) printing technology has emerged as an alternative to prior technology for creating 3D objects (e.g., various types of casting processes, various types of machining processes, various types of molding processes, etc.).

At a high level, 3D printing technology generally involves a 3D printing system that is capable of creating 3D objects from one or more materials (referred to herein as “object materials”) along with corresponding cloud-based or native software that functions to provide the 3D printing system with a 3D model. For instance, the 3D model may take the form of a data object representative of the 3D model for the object to-be-created. In practice, this data object may take the form of a computer-aided design (CAD) model that serves as the basis for the to-be-created 3D object. Such CAD models may take the form of one of a variety of data object types having an associated file-type/file-extension (e.g., a STEP file having a “.step” or “.stp” file-extension, a Wavefront object file-type having a “.obj” file-extension, a STL file-type having an “.stl” file-extension, a 3D Manufacturing Format (3MF) file-type having a “.3mf” file-extension, etc.). A 3D model for use as the basis for 3D printing an object-to-be created and its file-type and/or file-format may take various other forms, as well.

There are currently various different types of 3D printing technologies in existence that can be utilized to create 3D objects which may each comprise additive manufacturing technologies, which are processes in which object materials are added to a build for the object-to-be created. At a high level, example object-forming processes that may be implemented using additive manufacturing technologies include, but are not limited to including, depositing the object materials in a workspace to create an object, selectively sintering some object materials from a spread-layer of object materials to create a layer of an object, and/or fusing a first piece comprising object materials to a second piece comprising the object materials, among other possible processes involved in an additive manufacturing technology.

Other technologies exist for creating 3D objects, which comprise aspects of 3D printing technologies (such as additive manufacturing technologies), combined with another object-creation technology. These technologies may be referred to as hybrid manufacturing technologies. For example, a hybrid manufacturing technology may include one or more 3D printing technologies, along with one or more subtractive manufacturing technologies—each of which may be utilized during a process for creating an object-to-be-created. A subtractive manufacturing technology is a process in which object materials are removed from a build for the object—such as by utilizing a tool (e.g., a knife, a grinder, a drill, a lathe, a press, a milling machine, etc.) to selectively remove object materials from a build (and thus define a feature in the object), among other possible processes involved in a subtractive manufacturing technique.

Other types of 3D printing technology that utilize other object-production techniques (e.g., other than additive or subtractive techniques) may exist as well.

Further, existing types of 3D printing technology may be capable of creating any of various types of 3D objects from any of various types of object materials, such as, but not limited to, various plastics, various organic materials, and/or various metals.

Using 3D printing technology to create 3D objects from metal provides various advantages over other existing technology for creating 3D objects from other types of object material, including that objects created from metal tend to be more durable than objects created from non-metal material (e.g., plastic).

Accordingly, various entities desire 3D printing technologies that can accurately create robust objects out of metal materials, for various reasons. These reasons can range from the aesthetic (e.g., an entity wishes to 3D print custom jewelry out of metal materials), to the functional and/or experimental (e.g., an entity wishes to create a custom part to upgrade an existing machine's functionality), to the practical and/or economically efficient (e.g., a user of industrial machinery wishes to replace a broken part from the industrial machinery with a 3D printed part (e.g., based on an available 3D model for the part), rather than purchase a version of the part from the manufacturer of the industrial machinery or a third party). It is contemplated that there are various other reasons that an entity may desire 3D printing technologies for creating metal objects.

To meet these desires, various 3D printing technologies for creating objects from metal materials have been developed. Some example technologies for 3D printing objects that are metal include direct metal layer sintering (DMLS) technology, binder jet technology, and bound metal deposition (BMD) technology. These technologies are referenced for purposes of example and it is contemplated that other 3D printing technologies for creating metal objects exist.

Referring first to DMLS technology, DMLS refers to a process in which (i) a fine layer of metal object materials (e.g., in the form of a powder) are spread across a build platform, (ii) one or more large, powerful laser then selectively sinters the powder at the points defined by a 3D model (for an individual layer of the object-to-be created) to form a layer for a build of the object-to-be-created, and (iii) the formed layer is then allowed to reach a thermal-equilibrium point prior to (iv) repeating steps (i)-(iii) for the next layer of the object-to-be-created. It should be understood that this explanation of DMLS technology is merely exemplary, and the functionality involved in DMLS technology may take various other forms as well.

In contrast to the layer-wise sintering that is performed using DMLS technology, binder jet technology is one in which the object-to-be-created is all sintered at the same time-reducing the stresses caused by layer-wise sintering and subsequent returns to equilibrium temperatures. Binder jet technology refers to a process in which (i) a layer of object material is spread across a build platform, (ii) a print head (e.g., a print head comparable to an inkjet printer head) deposits a binder material on top of the powder in a pattern that conforms to a layer of the object-to-be created (as defined by a 3D model), (iii) then, the build platform is lowered prior to (iv) repeating steps (i)-(iii) for the next layer of the object-to-be-created, and, (v) after all layers of the object-to-be-created are bound using the binder material, sintering the object materials to thereby form the object. The binder material may be a chemical (e.g., an adhesive, a polymer material, etc.) that binds particles of the object material together to form the object-to-be-created in its pre-sintered form. It should be understood that this explanation of binder jet technology is merely exemplary, and the functionality involved in binder jet technology may take various other forms as well.

As another technology that uses binder material, BMD technology is a 3D printing technology in which a binder material is used in conjunction with metal object materials, but the machinery does not perform layer-by-layer spreading of materials. BMD technology refers to a process in which (i) metal materials are extruded onto a building platform in a layer-wise manner, wherein the metal materials are held together with a binder material to hold the layer's form, (ii) after each layer has been extruded onto the building platform, the binder material is removed from the build by, for example, bathing the build in a solvent that removes the binder material, and (iii) after the binder material is removed, the object-to-be-created is sintered in a furnace. Similar to the discussion of the binder material with reference to the binder jet technology, the binder material used for BMD technology may be a chemical (e.g., an adhesive, a polymer material, etc.) that binds particles of the object material together to form the object-to-be-created in its pre-sintered form. In some examples of BMD technology, the object material and binder material may combine to form a filament that is extruded to, ultimately, form the object-to-be-created. It should be understood that this explanation of BMD technology is merely exemplary, and the functionality involved in BMD technology may take various other forms as well.

While these technologies may each have some advantages over one another (or other known 3D printing technologies for creating metal objects), each referenced technology has its own drawbacks.

For instance, as a starting point, the existing 3D printing technology for creating metal objects (such as DMLS technology, binder jet technology, BMD technology, etc.) is costly. The primary reason for this is that 3D printing technologies for creating metal objects often require high tolerance (e.g., heat tolerance, required tolerances for precision of energy, required tolerances for accuracy of material deposition) components, which add cost to the bill of materials (BOM) of a machine for carrying out the 3D printing technology for creating metal objects.

For example, existing 3D printing technologies for creating metal objects typically include high-powered lasers (e.g., those used for DMLS technology) and/or electron beam guns, which are expensive components that increase the cost of such 3D printing technologies. As another example, material handling/spreading machinery (e.g., spreaders, movable build platforms, etc.) that are used for a variety of existing 3D printing technologies that spread object material over a build platform (e.g., DMLS technology, binder jet technology, etc.) can add significant cost to a BOM for 3D printing machinery. As yet another example, hybrid manufacturing technologies require very complex machinery (including, but not limited to, lasers and material handling/spreading machinery) that may come at a very high cost, given the various different tools needed to perform various additive and/or subtractive manufacturing technologies to create a given object-to-be-created using a hybrid manufacturing technology.

Various other, high-cost components may also be included in the existing 3D printing technologies, and the cost of such components (e.g., lasers, material handling/spreading machinery, etc.) is, ultimately, borne by the entity that desires to use/own the machinery, via the price to operate/own the machinery for a given 3D printing technology.

An additional cost-burden may be associated with 3D printing technologies that operate (i) on a layer-wise basis and (ii) generate each layer from successively spread layers of material. For example, both DMLS and binder jet technologies utilize spread layers of materials that are selectively interacted with (e.g., DMLS technology sintering the materials, binder jet technology binding the materials with a binder material, etc.) to form layers for the object-to-be created. During the build, excess object materials existing in the negative spaces of the object-to-be-created may then be discarded—either at the end of the build or during the layer-wise spreading of object materials. This may result in wasted materials, which increases the quantity of materials needed for a given build, which is ultimately another cost that is borne by the entity who wishes to use the 3D printing technology.

Further still, existing 3D printing technology for metal objects (e.g., binder jet technology, BMD technology, etc.) may introduce unwanted emissions or waste that (at best) can cause an unwanted mess or disruption in a work environment and (at worst) may be toxic or harmful to users and/or other property. For example, binder jet technology and/or BMD technology may involve removing binder materials (e.g., via chemical baths, burning, etc.), which may result in emissions that are harmful to anyone within an environment proximate to a machine carrying out the 3D printing technology.

To that end, entities that use the existing 3D printing technology for metal objects may, then, be compelled to mitigate these unwanted emissions in various ways (e.g., introducing additional ventilation proximate to the machinery, introducing requirements for users to wear more protective wear, introducing additional chemicals into a work environment to mitigate the effects of harmful emissions, etc.). In some examples, systems or processes for such mitigation may be built into a 3D printing system (e.g., extra venting, chemical depositors for mitigating chemicals, etc.). Either way, such mitigation increases the cost of the existing 3D printing technology for metal objects and may also increase the time and manpower required to create 3D objects using the existing 3D printing technology, which further degrades efficiency.

Given the many issues described above, the existing 3D printing technology for creating metal objects (such as DMLS, binder jet, and/or BMD technologies) may not only be inefficient and potentially unsafe but also tend to be so cost prohibitive in nature that the existing technology may be unavailable to some entities.

To address these and other problems with existing 3D printing technology, disclosed herein is a new 3D printing system for creating 3D objects. At a high level, the disclosed 3D printing system may function to create a 3D object by (i) dispensing at least a first type of material from which the 3D object is to be made (which as noted above may be referred to herein as an “object material” or could alternatively be referred to as a “model material”) and a second type of material that occupies negative space proximate to the object material and thereby serves as a “scaffold” or support mechanism for the object material (which may be referred to herein as “scaffold material”) into a volume-holding container referred to herein as a “crucible,” and then (ii) heating the crucible that contains the object and scaffold materials until the object material sinters, after which time the object and scaffold materials may be cooled and the scaffold material may be separated from the sintered object material via a tumbling process or the like (which may take place within the 3D printing system itself or within a separate tumbling unit) in order to produce the final 3D object.

In accordance with the present disclosure, the 3D printing system may include various components that work together to perform this functionality. For instance, the functionality for dispensing the object and scaffold materials may be carried out by a printing unit (under the control of the one or more computing units) that is configured to dispense the object and scaffold materials from nozzles that are connected to material canisters connected via feed lines-where such material canisters (either alone or together with the corresponding feed lines and nozzles) may be selectively installed or uninstalled so as to allow the object and scaffold materials to be replenished or switched to a different material type. In this respect, the printing unit could be configured to dispense material from as little as two nozzles that are connected to two material canisters (e.g., one canister that contains object material and one canister that contains scaffold material) or could be configured to dispense material from more than two nozzles that are connected to more than two material canisters (e.g., any number of material canisters containing object material of either the same type or different types, any number of material canisters containing scaffold material of either the same type or different types, and perhaps also any number of material canisters containing other types of material that may be useful to the sintering process for the object material). Further, in at least some implementations, the printing unit may function to dispense the object and scaffold materials into the crucible on a layer-by-layer basis, where each such layer may comprise a respective geometry of one or both of the object and scaffold materials. In turn, the functionality of heating the crucible that contains the object and scaffold materials until the object material sinters may be carried out by a furnace (under the control of the one or more computing units).

The architecture and functionality of the disclosed 3D printing system will be described in further detail below.

The disclosed 3D printing technology improves upon existing 3D printing technologies in various ways by improving efficiency and eliminating harmful waste/emissions, while still enabling a new 3D printing system architecture that is less expensive than many existing 3D printing systems that have architectures based on existing 3D printing technologies. By combining the use of object materials (for creating an object) and scaffold materials that have a higher sintering point (for supporting the object during the build), various drawbacks of prior 3D printing technologies may be mitigated.

First, the 3D printing technology disclosed herein can fully sinter all the object materials for the object, during a single period of time—which improves, in various ways, upon some prior 3D printing technologies that use layer-wise sintering of materials (e.g., DMLS technology). Using the disclosed 3D printing technology, a furnace need only heat a crucible during one period of time during the build (rather than repeatedly turning a heating element on and off with each layer-wise sinter). This may reduce the uneven stresses that occur with layer-wise sintering, as the object materials that have been sintered need not be repeatedly brought down to an equilibrium temperature, for a layer, and then have another sintered layer stacked thereon (thereby avoiding uneven, temperature-based stresses on the build).

Further, by using powder-based deposition of the object materials, as the object materials are surrounded by scaffold materials, (as opposed to laser-sintering) components of a printing unit for the disclosed 3D printing architecture may provide both (i) a lesser cost when compared to laser-based architectures and (ii) an ease of control of the printing unit, when compared to high-powered lasers. As mentioned above, certain 3D printing technologies (e.g., DMLS technology) requires one or more high-powered lasers to perform the above-mentioned layer-wise sintering, which not only adds cost but also adds engineering complexity, as it has proven difficult, in the industry, to focus and control large amounts of energy expelled from the laser with pinpoint precision for accurately sintering the object materials for a DMLS technology-based build.

Additionally, in comparison to some existing 3D printing technologies (e.g., DMLS technology, binder jet technology), the disclosed 3D printing architecture does not require costly material handling/spreading machinery. Due to use of depositing units that raise and lower independent of a build surface (e.g., a crucible) and the fact that there is no spread layer from which to sinter/bond object materials, this type of machinery is unnecessary—which provides an additional cost-advantage to an entity who wishes to use the disclosed 3D printing technology, in comparison to some other, prior 3D printing technologies.

Further yet, because the disclosed 3D printing technology does not involve successive spreading of layers of object material on a build platform, the disclosed 3D printing technology, when carried out, does not result in similar waste in object materials compared to 3D printing technologies that use material spreading for successive layers (e.g., DMLS technology, binder jet technology)—which reduces the risk of hazard (because there will not be large quantities of loose powder) as well as reducing cost. Indeed, even if the scaffold materials are, ultimately, discarded at completion of a build of an object, the scaffold materials may, generally, be of lower cost to the object materials and, thus, this still is a cost-advantage of the disclosed 3D printing technology, over some prior 3D printing technologies.

Further still, the 3D printing technologies disclosed herein may eliminate the need to use various, potentially-harmful chemicals (e.g., solvents utilized prior to sintering, binder materials, etc.), in order to create a 3D object. For example, the 3D printing technologies disclosed herein may not utilize materials that, when heated, cause for an excess of chemical emissions to enter an environment, in which the 3D printing technologies are carried out. In comparison to existing technologies that must remove certain materials that cause emissions when removed (e.g., the binder materials utilized in binder jet technology and/or BMD technology), the disclosed 3D printing technology does not suffer from this drawback. Instead, the entity that wishes to use the disclosed 3D printing technology receives a cost-advantage, in comparison to these existing technologies, as the entity need not introduce (potentially costly) emissions mitigation hardware and/or techniques.

Altogether, the disclosed 3D printing technology that uses simultaneous object and scaffold material deposition may introduce significant cost savings for an entity that wants to create 3D objects from metal. Now, 3D printing technology for printing objects made of certain materials (e.g., metal materials) are now available to various entities (e.g., individuals, small businesses, educational institutions, etc.) that may have been unable to afford the expensive machinery needed to carry out the prior, existing 3D printing technologies for 3D printing objects made of such materials.

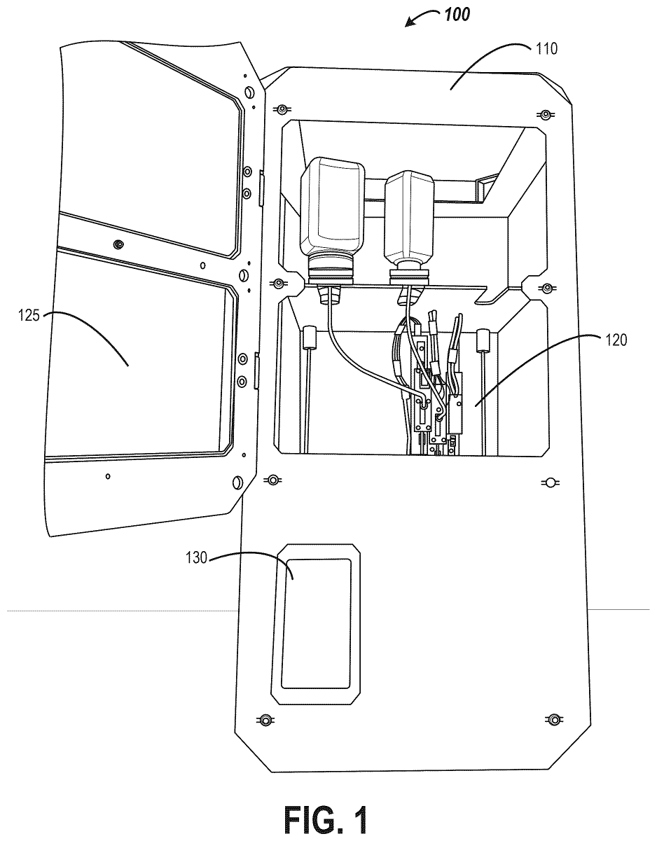

The improvements that are provided by the disclosed 3D printing technology are described in further detail below. Turning now to the drawings, FIG. 1 depicts an exterior view of an example 3D printing system 100, in accordance with the present disclosure. The 3D printing system 100 may comprise a housing 110 that surrounds an interior chamber 120 within which the other components of the 3D printing system 100 may be housed. For instance, although not specifically shown in FIG. 1, the housing 110 may house a printing unit, a set of two or more material canisters that are connected to nozzles via feed lines, a crucible, a furnace, and one or more computing units, among other possible components that may be placed within the interior chamber 120 defined by the housing 110.

The housing 110 may generally comprise any type of material that is robust enough to maintain form during exposure to the heat that is produced by the 3D printing process (e.g., a material with a high sintering point), while still mitigating enough heat that the surface of the housing 110 would not emanate excessive heat on its exterior surface(s). Examples of such materials that could absorb heat without excessively emanating the heat to the outside environment are aluminum materials or aluminum alloy materials, among other possible types of such materials.

Further, the housing 110 may have any of various shapes and sizes. For instance, the housing 110 could have a cube or cube-like shape having size that would allow the example 3D printing system 100 to be kept on a desktop or tabletop that may be found with an office, a home, a laboratory, or the like. However, it should be understood that the housing 110 of the 3D printing system 100 could have various other shapes and sizes as well, including but not limited to the possibility that the housing 110 may have a larger size that may not be suited for placement on a desktop or tabletop.

Further yet, it is possible that the interior chamber 120 within the housing 110 could be divided into multiple sub-chambers. For instance, as shown in FIG. 1, the interior chamber 120 could be adapted to include one sub-chamber for housing the material canisters and another sub-chamber for housing the printing unit, the crucible, and the furnace. Additionally, although not specifically shown in FIG. 1, the interior chamber 120 could also include another sub-chamber for housing the one or more computing units. The interior chamber 120 could be adapted to include various other sub-chambers that house various other subsets of the internal components of the 3D printing system 100 as well.

Still further, although not shown in FIG. 1, it is possible that the 3D printing system 100 is designed to allow for the material canisters to be placed external to the interior chamber 120 of the housing 110, such as by allowing the material canisters to be affixed to the top of the housing 110, among other possible exterior positions of the material canisters.

The housing 110 and interior chamber 120 take various other forms as well.

In line with the discussion above, regardless of their specific form, the housing 110 and interior chamber 120 may also be designed to allow the material canisters (either alone or together with the corresponding feed lines and nozzles) to be selectively installed or uninstalled. For instance, the housing 110 and interior chamber 120 may be designed such that at least a portion of the interior chamber 120 (e.g., a given sub-chamber) can be accessed for purposes of installing or uninstalling one or more material canisters.

For example, in a scenario where the 3D printing system 100 does not come pre-installed with any material canisters, a user may access the interior chamber 120 of the 3D printing system 100 in order to install an initial set of material canisters (either alone or together with the corresponding feed lines and nozzles) for use in printing a 3D object. As another example, in a scenario where a given material canister has been used to the point of no longer having enough material to print further 3D objects, a user may access the interior chamber 120 of the 3D printing system 100 in order to uninstall the given material canister and replace it with a new material canister, which may contain the same type of material or perhaps a different type of material. As yet another example, in a scenario where a user decides to use a different type of object and/or scaffold material to print future 3D objects, the user may access the interior chamber 120 of the 3D printing system 100 in order to uninstall at least one of the currently-installed material canisters (e.g., an object material canister, a scaffold material canister, or both) and replace it with at least one new material canister containing a different type of material. As still another example, in a scenario where a user decides to switch from using a single type of object and/or scaffold material to using multiple types of object and/or scaffold material to print future 3D objects, the user may access the interior chamber 120 of the 3D printing system 100 in order to install at least one additional material canister containing at least one additional type of object or scaffold material. Other scenarios where the interior chamber 120 of the 3D printing system 100 may be accessed for purposes of installing and/or uninstalling a material canister are possible as well.

In each of the foregoing scenarios, if the material canisters come pre-connected to feed lines and nozzles that are to be installed and uninstalled along with the material canisters (e.g., a material canister, feed line, and nozzle are designed to be a single “consumable unit”), then the act of installing or uninstalling a material canister may likewise involve installing or installing the material canister's corresponding feed line and nozzle. Alternatively, if the material canisters are designed to be selectively connected to or disconnected from feed lines and nozzles that are built-in components of the 3D printing system 100 (i.e., components that are not intended to be replaced unless they are damaged or the like), then the act of installing or uninstalling a material canister may involve connecting the material canister to or disconnecting the material canister from a built-in feed line (and corresponding nozzle) that is within the 3D printing system 100.

As shown in FIG. 1, in at least some implementations, the housing 110 may also comprise a cutout within which a window 125 may be inserted, such that a user of the 3D printing system 100 can view the 3D printing system 100 carrying out the disclosed 3D printing functionality within the interior chamber 120. (As used herein, a “user” of the 3D printing system 100 may refer to any individual that is involved in the process of printing a 3D object using the 3D printing system 100, including any individual that is observing the process). The window 125 may comprise any suitable material (e.g., glass) that is transparent or translucent such that a user of the 3D printing system 100 can observe the interior chamber 120. For example, the window 125 may provide a user of the 3D printing system 100 with a view to observe certain of the internal components of the 3D printing system 100 (which will be described in further detail below) while it is engaging in the functionality for dispensing the object and scaffold materials into the crucible, among other possible functionalities that may be observed via the window 125.

As further shown in FIG. 1, in at least some implementations, the 3D printing system 100 may comprise at least one input/output (I/O) interface, such as a touchscreen 130, that enables a user to interact with the 3D printing system 100 by doing one or both of (i) providing input to the 3D printing system 100 (e.g., input for configuring and/or controlling the 3D printing system 100) and (ii) being presented with an output by the 3D printing system 100 (e.g., textual or graphical information related to the current state and/or operation of the 3D printing system 100). The I/O interface of the 3D printing system 100 may take various other forms as well, including but not limited to the possibility that the I/O interface may include other I/O components in addition to or instead of the touchscreen 130.

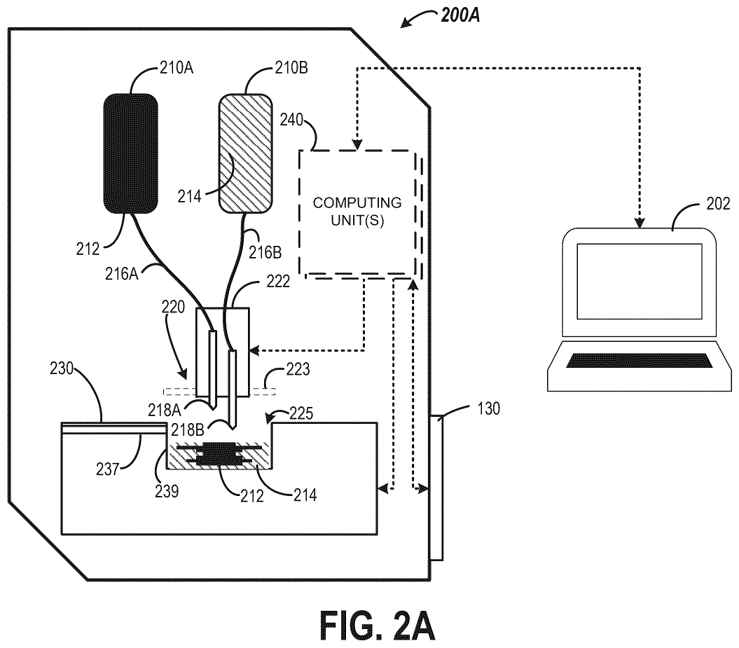

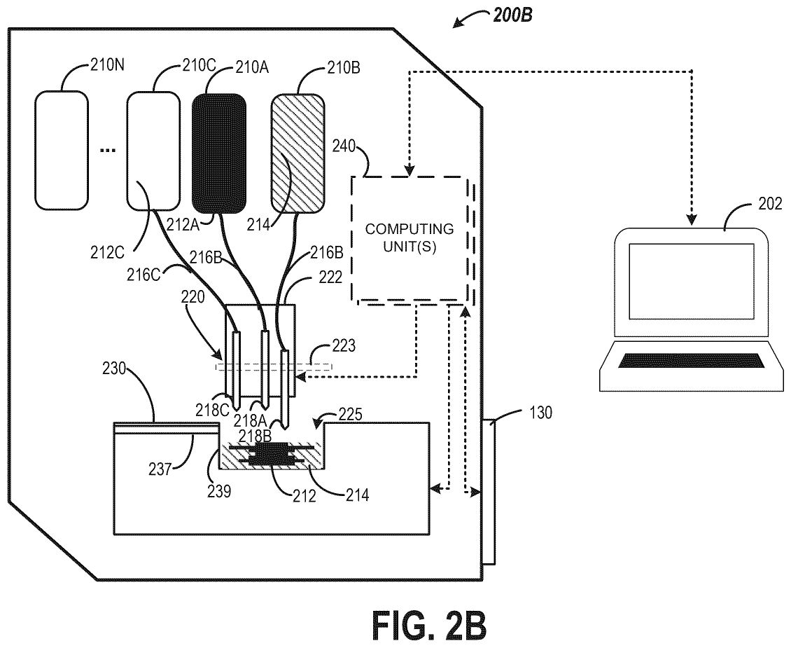

FIG. 2A shows one possible example of the internal architecture of an example 3D printing system 200A along with a client device 202 that is capable of interacting with the example 3D printing system 200A, in accordance with the present disclosure. As shown in FIG. 2A, the internal architecture of the example 3D printing system 200A may include at least two material canisters 210 that each contain a type of material for use in printing a 3D object (which may be referred to herein as a “printing-process material”) and each has a corresponding feed line 216 and a corresponding nozzle 218, a printing unit 220 (which could also be referred to as a “printing head”), a crucible 225, a furnace 230, and one or more computing units 240. In the depicted example, the example 3D printing system 200A is shown to include two material canisters 210A, 210B along with corresponding feed lines 216A, 216B and nozzles 218A, 218B, but this is merely for purposes of illustration, and in other examples, it is possible that the disclosed 3D printing system may include more than two material canisters 210. One such example is shown and described below with reference to FIG. 2B. The internal architecture of the disclosed 3D printing system may take various other forms as well, including, but not limited to, the possibility that it includes additional or alternative components or that certain components shown are removed or combined.

At a high level, the depicted components of the example 3D printing system 200A may work together to create a 3D object. In particular, the printing unit 220 (under the control of the one or more computing units 240) may function to dispense the printing-process materials from the nozzles 218 that are connected to the material canisters 210 (e.g., on a layer-by-layer basis) into the crucible 225. In turn, the furnace 230 (under the control of the one or more computing units 240) may function to heat the crucible 225 that contains the object and scaffold material until the object material sinters, after which time the object and scaffold material may be cooled and the scaffold material 214 may be separated from the sintered object material 212 via a finishing process such as tumbling, media blasting, or the like (which may take place within the 3D printing system 200 itself or within a separate finishing machine) in order to produce the final 3D object comprising the sintered object material 212. Each of these components of the example 3D printing system 200 will now be described in further detail.

To begin, as introduced above, the example 3D printing system 200A is shown to include two material canisters 210: (i) a first material canister 210A that contains an object material 212, which as noted above is a type of material from which the 3D object is to be made, and (ii) a second material canister 210B that contains a scaffold material 214, which as discussed above is a type of material that serves as a scaffold or support mechanism for the object material 212. However, in line with the discussion above, the depicted example is merely shown for purposes of illustration, and in other examples, it is possible that the disclosed 3D printing system may include more than two material canisters 210.

Each of these material canisters 210 may generally comprise any type of canister that is capable of (i) being filled with a given type of printing-process material (e.g., a given type of object or scaffold material), and (ii) feeding such printing-process material via a corresponding feed line 216 to a corresponding nozzle 218. In this respect, each of the material canisters 210 may have any suitable shape that allows for a printing-process material contained within the material canister 210 to gravitate to the corresponding feed line 216 and nozzle 218, examples of which may include a wedge-like shape, a cube-like shape, a cylindrical-like shape, a prismatic shape, and/or some other non-planar shape, among other possibilities. Further, each of the material canisters 210 may be made of any type of material that is suitable for containing the types of printing-process materials described herein, examples of which may include material canisters 210 made of a plastic or metal material, among other possibilities. Further yet, each of the material canisters 210 may have any suitable size for use in containing the printing-process materials described herein. The material canisters 210 may take any of various other physical forms as well.

In line with the discussion above, in at least some implementations, the example 3D printing system 200A may be designed such that each of the material canisters 210 (either alone or together with the corresponding feed line 216 and nozzle 218) can be selectively installed or uninstalled (i.e., the material canisters are removable and replaceable). And such implementations, the example 3D printing system 200A may include receptacles (e.g., in the interior chamber defined by the housing) that are adapted to hold the material canisters 210 in place after installation while also allowing such material canisters 210 to be selectively released and removed when uninstalling and replacing the material canisters 210. However, in other implementations, the example 3D printing system 200A be designed such that each of the material canisters 210 comprises a re-fillable material container that is fixed in place (e.g., in the interior chamber defined by the housing) and gets re-filled with new material (of either the same type or a different type) when it no longer contains a sufficient amount of printing-process material.

The material canisters 210 could take other forms and/or be positioned in other ways as well.

As illustrated in FIG. 2A and subsequent figures that show use of the materials 212, 214 that are held in the material canisters 210, the object material 212 is depicted as a solid black fill (in both the depiction of its containment within the first material canister 210A and when depicted within the crucible 225) and the scaffold material 214 is depicted with a downward angled hatching (in both its containment in the second material canister 210B and when depicted within the crucible 225).

In accordance with the present disclosure, the object material 212 that is contained within the material canister 210A and the scaffold material 214 that is contained within the material canister 210B may each take various forms.

Beginning with the object material 212, such object material may generally comprise any type of material from which a 3D object can be made. For instance, as one possibility, the object material 212 may be a metal material (e.g., aluminum, copper, steel, platinum, gold, among any other known metal materials and/or any alloys thereof). As another possibility, the object material 212 may be a type of non-metal, material, such as a glass material, a ceramic material, a plastic material, or a biological material (e.g., a biologic agent, etc.), among other possible types of non-metal materials that may be usable for printing 3D objects.

Further, the object material 212 that is contained within the material canister 210A may be in any form that allows the material to be fed from the material canister 210A via the feed line 216A to the nozzle 218A and then dispensed from the nozzle 218A by the printing unit 220, including but not limited to any form of material that (i) acts more like a solid when inside the material canister 210A, (ii) acts more like a fluid when flowing from the material canister 210A via the feed line 216A to the nozzle 218A and then out of the nozzle 218A into the crucible 225 (where such flow may be assisted by applying vibration as discussed in further detail below), and then (iii) again acts more like a solid when inside the crucible 225. For instance, as one possibility, the object material 212 may be in a powdered form (e.g., a composition of dry particles or granules), which may have the foregoing properties of acting more like a solid within the material canister 210A and the crucible 225 and acting more like a fluid when flowing from the material canister 210A via the feed line 216A to the nozzle 218A and then out of the nozzle 218A into the crucible 225. However, it is contemplated that the object material 212 could take other forms as well, such as a viscous, semi-solid liquid form (e.g., a gel form).

Turning next to the scaffold material 214, such scaffold material may generally comprise any type of material that can serve as a scaffold or support mechanism for the object material 212 by occupying negative space proximate to the object material 212 during the printing process. In order to accomplish this purpose, the scaffold material 214 may comprise a type of material that (i) preserves the geometric definition of the object material 212 during the sintering process, (ii) can be removed from sintered object material 212 after the sintering process has been completed (e.g. via mechanical, thermal, or chemical means), and (iii) does not chemically interact with the object material 212 in a negative way either before, during, or after the sintering process (although this does not preclude the possibility of using a material that chemically interacts with the object material 212 in a neutral or positive way). For instance, as one possibility, the scaffold material 214 may comprise a type of material having a higher sintering point than the object material 212 such that the scaffold material 214 will not itself fully sinter during the sintering process and can thereafter be separated from the sintered object material 212. However, as another possibility, the scaffold material 214 may comprise a type of material that will fully sinter during the sintering process but can nevertheless be removed from the object material 212 thereafter (e.g., by dissolving the sintered scaffold material 214).

Further, in at least some implementations, the scaffold material 214 may comprise a type of material that also has an abrasive texture (in addition to having the higher sintering point relative to the object material 212) or at least has certain characteristics that allow the scaffold material 214 to function as an abrasive relative to the object material 212 (e.g., by having a hardness level that exceeds the hardness level of the object material 212), which enables the scaffold material 214 to serve a secondary purpose of polishing, smoothing, deburring, and/or cleaning the sintered object material 212 during the finishing process for the 3D object.

One possible type of the scaffold material 214 that has the foregoing properties may include an inert material that is chemically inactive and does not react with other substances under normal conditions, examples of which may include a sand, ceramic, and/or carbon material that has both a higher sintering point than most types of the object material 212 (e.g., metal) and an abrasive texture. However, other types of scaffold material are possible as well. Further, in practice, the scaffold material 214 could comprise a single type of material (e.g. ceramic alone) or a mixture of multiple types of materials. For example, the scaffold material 214 could comprise a mixture of ceramic or refractory material along with one or more additives that help to facilitate some aspect of the functionality carried out by the 3D printing system 200A, such as an additive that helps to improve the properties or finish of the created 3D object, an additive that helps to improve flowability within the 3D printing system 200A, an additive that helps with thermal control during sintering, an additive that helps with separation of the scaffold material 214 from the sintered object material 212, and/or an additive that helps with sintering chemistry or oxide prevention, among other possible types of additives that may be added.

The scaffold material 214 make take various other forms as well.

Further, as with the object material 212, the scaffold material 214 that is contained within the material canister 210B may be in any form that allows the material to be fed from the material canister 210B via the feed line 216B to the nozzle 218B and then dispensed from the nozzle 218B by the printing unit 220, including but not limited to any form of material that (i) acts more like a solid when inside the material canister 210B, (ii) acts more like a fluid when flowing from the material canister 210B via the feed line 216B to the nozzle 218B and then out of the nozzle 218B into the crucible 225, and then (iii) again acts more like a solid when inside the crucible 225. For instance, as one possibility, the scaffold material 214 may be in a powdered form (e.g., a composition of dry particles or granules). However, it is contemplated that the scaffold material 214 could take other forms as well.

As noted above and described in further detail below, it is possible the material canisters 210 could contain printing-process materials of other types as well, such as an additional printing-process material that is intended to help facilitate some aspect of the functionality carried out by the 3D printing system 200A, such as the sintering process.

As introduced above and shown in FIG. 2, the material canisters 210 may each be connected to a corresponding feed line 216 that functions to transport the printing-process material from the material canister 210 to a corresponding nozzle 218 that is connected to the feed line 216. In particular, the first material canister 210A is shown to be connected to a first feed line 216A that is in turn connected to a first nozzle 218A, and the second material canister 210A is shown to be connected to a second feed line 216B that is in turn connected to a second nozzle 218B. However, in line with the discussion above, the depicted example is merely shown for purposes of illustration, and in other examples, it is possible that the disclosed 3D printing system may include more than two feed lines 216 and corresponding nozzles 218.

Each of the feed lines 216 may generally comprise any type of hollow, connective body that enables a printing-process material (e.g., the object or scaffold materials 212, 214) to travel between the material canister 210 and the nozzle 218 that are connected to the feed line 216 while the printing unit 220 is engaging in the process of dispensing the printing-process material from the nozzle 218 into the crucible 225. For instance, as one possibility, each of the feed lines 216 may be comprised of a type of material that has relatively low friction and is also flexible so as to allow the feed lines 216 to move and flex while feeding the printing-process material from the material container 210 to the nozzle 218, which may be in motion during the process of dispensing the printing-process material into the crucible 225 as described below. Examples of such types of material may include, but are not limited to including, a polyethylene terephthalate (PET) material, a polytetrafluoroethylene (PTFE) material, a nylon material, and/or a fluorocarbon material, among other possibilities.

The feed lines 216 may take various other forms as well.

In turn, the nozzles 218 that are connected to the feed lines 216 may each comprise any type of component is capable of (i) receiving a printing-process material from a corresponding material canister 210 via a corresponding feed line 216, and (ii) selectively releasing the printing-process material under the control of the printing unit 220 during the process of dispensing printing-process material into the crucible 225, which will be described in further detail below. In this respect, each of the nozzles 218 may serve as a rigid end-effector of a corresponding feed line 216. Such a nozzle 218 may take any of various forms.

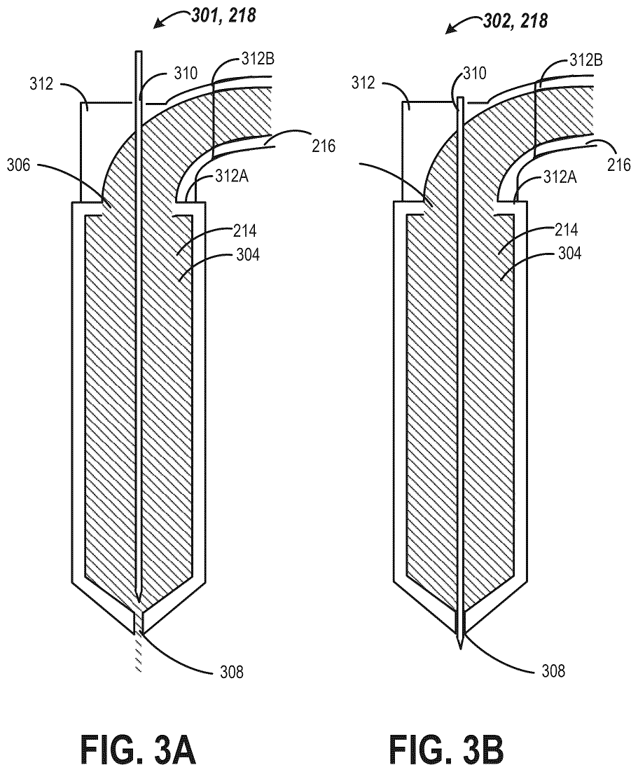

One possible implementation of the nozzles 218 of the example 3D printing system 200A is illustrated in FIGS. 3A-3B, which show first and second cross sectional views 301, 302 of an example nozzle 218. In FIGS. 3A-3B, the example nozzle 218 is shown to include (i) a hollow body that includes an inner chamber 304, a top orifice 306 through which a printing-process material may flow from a feed line 216 into the inner chamber 304, and a bottom orifice 308 through which the printing-process material may flow out of the inner chamber 304, (ii) a valve stem 310 that is positioned within the inner chamber 304 and is movable within the inner chamber in order to selectively open (i.e., unseal) or close (i.e., seal) the bottom orifice 308, and (iii) a connector 312 on the top end of the example nozzle 218 that is configured to both connect the example nozzle 218 to a feed line 216 and also provide an interface through which the valve stem 310 may be connected to the printing unit 220, among other possible components of the example nozzle 218. In this respect, FIG. 3A shows the example nozzle 218 at a first time when the valve stem 310 is in a raised position and the bottom orifice 308 is open, while FIG. 3B shows the example nozzle 218 at a time when the valve stem 310 is in a lowered position and the bottom orifice 308 is closed.

The exterior of the example nozzle's hollow body may have any of various shapes. For example, as shown, the exterior of the hollow body may have a cylindrical shape that tapers into a conical shape at the bottom end of the example nozzle 218. However, the hollow body could have various other exterior shapes as well.

Further, the inner chamber 304 of the example nozzle's hollow body may have any of various shapes. For example, as shown, the inner chamber 304 of the hollow body may similarly have a cylindrical shape that tapers into a conical shape at the bottom end of the example nozzle 218. However, the inner chamber 304 could have various other shapes as well.

Further yet, the exterior, inner chamber 304, and top and bottom orifices 306, 308 of the example nozzle's hollow body could have any of various dimensions, which may depend on the implementation of the 3D printing system 200A and/or the type of printing-process material to be deposited from the example nozzle 218, among other possible factors.

The example nozzle's hollow body could take various other forms as well.

Referring again to FIGS. 3A-3B, the valve stem 310 that is positioned within the example nozzle's hollow body could also have any of various shapes and dimensions. For example, as shown, the valve stem 310 may have a cylindrical shape that tapers into a conical shape at the bottom end of the value stem 310 (e.g., similar to a needle) and has a diameter that allows the valve stem 310 to seal the bottom orifice 308 when the valve stem 310 is in a lowered position. However, the valve stem 310 could have various other shapes and/or dimensions as well, including but not limited to the possibility that the valve stem 310 may have a cylindrical shape (or some other uniform shape) from top to bottom rather than tapering near the bottom.

Further, the valve stem 310 of the example nozzle 218 could be made from any of various types of materials, including but not limited to any of various types of metal materials. However, the valve stem 310 could be made from various other types of non-metal materials as well.

The example nozzle's valve stem 310 could take various other forms as well.

Referring yet again to FIGS. 3A-3B, the connector 312 could take any of various forms. For example, as shown, the connector 312 may take the form of Y-shaped connector having three connector interfaces: (i) a first connector interface 312A on a bottom end of the connector 312 that mates with the top end of the hollow body, (i) a second connector interface 312B on a top end of the connector that mates with a corresponding feed line 216 (which may be fed through or otherwise coupled to the first connector interface 312B), and (ii) a third connector interface 312C on a top end of the connector through which the valve stem 310 protrudes so as to allow the valve stem 310 to be connected to and moved by the printing unit 220.

The example nozzle's connector 312 could take various other forms as well.

In operation, when the valve stem 310 is in a raised position and the bottom orifice 308 is open as shown in FIG. 3A, printing-process material that is contained within the inner chamber 304 of the example nozzle 218 will be able to flow through the bottom orifice 308 and be released from the example nozzle 218. As such, the printing unit 220 may function to place the example nozzle 218 into this open state whenever the printing unit 220 is actively dispensing the printing-process material from the example nozzle 218 into the crucible 225. Additionally, as discussed in further detail below, the printing unit 220 may also function to apply vibration to the example nozzle 218 while it is in an open state in order to help induce the printing-process material to flow through the bottom orifice 308.

On the other hand, when the valve stem 310 is in a lowered position and the bottom orifice 308 is closed as shown in FIG. 3B, printing-process material that is contained within the inner chamber 304 of the example nozzle 218 will be unable to flow through the bottom orifice 308. In this way, the valve stem 310 may serve as a type of “stopper” that blocks the flow of printing-process material through the bottom orifice 308. As such, the printing unit 220 may function to place the example nozzle 218 into this closed state whenever the printing unit 220 is not actively dispensing the printing-process material from the example nozzle 218 into the crucible 225 (e.g., times when the printing unit 220 is not dispensing printing-process material from any nozzle 218 or is dispensing printing-process material from a different nozzle 218).

When the valve stem 310 is moved from a raised position to a lowered position (e.g., in order to transition the example nozzle 218 from an open state to a closed state), the valve stem 310 may also perform a secondary function of clearing the bottom orifice 308 from obstruction by breaking apart and/or forcing out clumps of the printing-process material that have formed in the inner chamber 304 near the bottom orifice 308 and could present a risk of obstructing the flow of the printing-process material through the bottom orifice 308.

The manner in which the printing unit 220 functions to move the valve stem 310 of the example nozzle 218 and thereby control the open/closed state of the example nozzle 218 will be described in further detail below.

The example configuration of the nozzle 218 in FIGS. 3A-3B is shown for the purposes of illustration and explanation and it should be understood that the nozzles 218 of the example 3D printing system may take various other forms, as well. For example, it is possible that a different mechanism could be used to selectively open or close the bottom orifice of the nozzles 218. As another example, it is possible that the nozzles 218 could include a mechanism for selectively opening or closing the top orifice of the nozzles 218 so as to control the flow of printing-process material from the feed line 216 into the nozzle 218—which could be included either in addition to the nozzle's valve stem or in alternative to the value stem. Other variations of the nozzle 218 are possible as well.

Referring back to FIG. 2A, as shown, the material canisters 210, the feed lines 216, and the nozzles 218 may be physically positioned within the example 3D printing system 200A in a way that leverages the effects of gravity to help cause the printing-process materials to travel from the material canisters 210 through the feed lines 216 to the nozzles 218 while the printing unit 220 is engaging in the process dispensing the printing-process materials from the nozzles 218 into the crucible 225. For instance, the material canisters 210 may be positioned at a greater height than the nozzles 218, which may leverage the effects of gravity to help cause the print-process materials to travel from the material canisters 210 through the feed lines 216 to the nozzles 218. However, in practice, the effects of gravity alone may not be sufficient to cause the printing-process materials to travel from the material canisters 210 through the feed lines 216 to the nozzles 218—or at least may not be sufficient to cause the printing-process materials to travel from the material canisters 210 through the feed lines 216 to the nozzles 218 at the fast enough rate to facilitate the printing process.

To address this, the example 3D printing system 200A may also be configured to apply vibration to any one or more of the material canisters 210, the feed lines 216, and/or the nozzles 218 in order to help facilitate the movement of the printing-process materials from the material canisters 210 through the feed lines 216 to the nozzles 218. For example, although not specifically shown in FIG. 2A, the example 3D printing system 200A may include any one or more of (i) a first set of material-canister vibrators that are each configured to apply vibration to a respective one of the material canisters 210 (e.g., vibrators affixed to the receptacles for the material canisters 210) in order to help facilitate flow of a printing-process material contained within the material canister 210, (ii) a second set of feed-line vibrators that are each configured to apply vibration to a respective one of the feed lines 216 (e.g., vibrators that can be clipped onto the feed lines 216) in order to help facilitate flow of a printing-process material through the feed line 216, and/or (iii) a third set of nozzle vibrators that are each configured to apply vibration to a respective one of the nozzles 218 (e.g., vibrators that are included as part of the printing unit 220 as shown and discussed further below) in order to help facilitate flow of a printing-process material out of the nozzles 218. In this respect, each such vibrator could take any of various forms, examples of which may include a type of vibrating motor (e.g., a brushless or brushed direct current (DC) motor with an attached eccentric mass, a haptic vibration motor, a motor of the type found in various consumer products, etc.,), a linear-resonance actuator, or a transducer or coil (e.g., an ultrasonic transducer, voice coil, etc.), among various other possible types of vibrator components.

Further, in operation, the one or more sets of vibrators may be controlled by the one or more computing units 240, which may function to selectively switch the vibrators on or off as appropriate. For instance, when there is a desire to induce the flow of a given type of printing-process material from a given material canister through a given feed line and then out of a given nozzle, the one or more computing units 240 may selectively switch the one or more vibrators that are associated with the given material canister, the given feed line, and given nozzle from an off state to an on state (while keeping the other vibrators switched off) and may then keep such one or more vibrators in the on state for a period of time during which the printing unit 220 is dispensing the printing-process material from the given nozzle 218 into the crucible 225, after which time the one or more computing units 240 may switch the one or more vibrators from the on state back into the off state. The manner in which the one or more computing units 240 control the vibrators may take various other forms as well.

Based on the foregoing, it will be appreciated that each material canister 210 works in combination with a corresponding feed line 216 and nozzle 218 to deliver a printing-process material into the crucible 225 under the control of the printing unit 220. In this respect, each respective combination of a material canister 210 and its corresponding feed line 216 and nozzle 218 may define a respective flow path for a respective printing-process material. The manner in which each such combination of a material canister 210 and its corresponding feed line 216 and nozzle 218 are attached together may take any of various forms. For instance, in at least some implementations, each material canister 210 and its corresponding feed line 216 and nozzle 218 may be bonded together (e.g., via glue or the like) to form a single, consumable unit that can be selectively installed within or uninstalled from the example 3D printing system 200A, which may eliminate (or at least substantially reduce) the risk that a user will be exposed to printing-process material during the task of installing or uninstalling a material canister 210 because the flow path of the material will be closed. However, in other implementations, the material canister 210 may a physically-separate component that is designed to be selectively connected to or disconnected from a feed line 216 (and corresponding nozzle 218) that is a built-in component of the example 3D printing system 200A (i.e., a component that is not intended to be replaced unless it is damaged or the like).

Other implementations of the material canisters 210 and their corresponding feed lines 216 and nozzles 218 are possible as well.

Turning next to the printing unit 220, as introduced above, the printing unit 220 generally functions to engage in a process for dispensing printing-process materials (e.g., the object and scaffold materials 212, 214) from the nozzles 218 into the crucible 225. In operation, the printing unit 220 performs this process under the control of the one or more computing units 240, which may instruct and cause the printing unit 220 to dispense the printing-process materials from the nozzles 218 into the crucible 225 on a layer-by-layer basis in accordance with a set of layer-by-layer “print-paths” that define where the printing unit 220 is to deposit the printing-process material(s) in each layer.

In this respect, the available 3D space within the crucible 225 may be divided into a set of vertically-stacked 3D “slices” of the available 3D space, where each such 3D slice is positioned at a different respective position within the vertical dimension of the available 3D space and occupies a different respective portion of the vertical dimension of the available 3D space while occupying the entire horizontal plane of the available 3D space at the respective position within the vertical dimension, and the layers of printing-process material(s) to be deposited by the printing unit 220 may each correspond to a respective one of these 3D slices of the available 3D space within the crucible 225. For instance, the layers of printing-process materials to be deposited by the printing unit 220 may include a first layer of printing-process material(s) that corresponds to a first 3D slice of the crucible's available 3D space that sits at the bottom of the crucible 225, a second layer of printing-process material(s) that corresponds to a second 3D slice of the crucible's available 3D space that sits above the first 3D slice, a third layer of printing-process material(s) that corresponds to a third 3D slice of the crucible's available 3D space that sits above the second 3D slice, and so on, with a final layer of the printing-process material(s) corresponding to a final 3D slice of the crucible's available 3D space that sits above all of the other 3D slices of the crucible's available 3D space. In this respect, each of the layers of printing-process material(s) may be defined in terms of the layer's respective vertical position within the crucible's available 3D space-such as the vertical position of the bottom of the layer, the vertical position of the top of the layer, or both. Further, each of the layers of printing-process material(s) may have a respective height (referred to herein as a “layer height”) that defines how thick the layer is within the vertical dimension, which may either be the same across all of the layers of printing-process material(s) that are to be deposited or may differ from layer to layer.

In particular, in some implementations, the layers of printing-process material(s) may all have the same, fixed layer height that may be determined based on various factors-examples of which may include the geometry of the 3D object to be created, the particle size of the printing-process material(s), the angle of repose of the printing-process material(s), and/or time constraints for completing the printing process (because smaller layer height means more layers and thus a longer printing time), among other possible factors. In this respect, the determination of the fixed layer height may involve an evaluation of which layer heights strike an acceptable balance between having small enough layers to allow the printing process to achieve an acceptable level of performance (e.g., in terms of granularity, precision, avoidance of interruptions or errors, etc.) and having large enough layers to allow the printing process to complete within an acceptable amount of time (and perhaps also to ensure that there is sufficient space for the printing-process material(s) to flow out of the nozzles 218). To illustrate with one representative example, a fixed layer height for all of the layers of printing-process material(s) could be within a range of 20 microns to 200 microns, but it is also possible that a fixed layer height could be less than 20 microns or greater than 200 microns in some scenarios (e.g., if the nature of the 3D object being created and/or printing-process materials warrants it).

In other implementations, the layers of printing-process material(s) may have variable layer heights that may differ on a layer-by-layer basis. In this respect, the variable layer heights of the layers of printing-process material(s) respective heights may be determined based on an analysis of similar factors to those described above, including but not limited to the geometry of the 3D object to be created, the particle size of the printing-process material(s), the angle of repose of the printing-process material(s), and/or time constraints for completing the printing process, among other possible factors. In practice, this analysis may be performed by a software application that is tasked with the responsibility for generating the print-paths for the 3D object to be created. To illustrate with an example, such a software application may analyze how the geometry of the 3D object changes within the vertical dimension and may then define the variable layer heights (and thus the vertical position) of the different layers such that greater layer heights are used at points within the vertical dimension where the 3D object has more geometric uniformity and lesser layer heights are used at points within the vertical dimension where the 3D object has more geometric diversity, among other possible ways that the variable layer heights may be determined.

The layers of printing-process material(s) may have layer heights that take other forms and/or determined in other manners as well—including but not limited to the possibility that (i) certain of the layers could have a top and/or bottom surface that is non-planar (i.e., layers that are not perfectly flat) and/or (ii) certain of the layers may not occupy the entire horizontal plane of the available 3D space of the crucible 225 (e.g., in a scenario where a first given layer has a non-planar top surface that dips down to create one or more negative spaces within the first given layer that are to be filled by a second given layer).

Further, the set of layer-by-layer print-paths that define where the printing unit 220 is to deposit the printing-process material(s) in each layer may comprise, for each given layer, a respective print-path for each type of printing-process material to be deposited within that given layer. For instance, in the example 3D printing system 200A shown in FIG. 2A that includes two material canisters 210A, 210B respectively containing object material 212 and scaffold material 214, the set of layer-by-layer print-paths may include, for each given layer, either or both of (i) an object-material print-path for the given layer that defines where the printing unit 220 is to deposit the object material 212 within the given layer and/or (ii) a scaffold-material print-path for the given layer that defines where the printing unit 220 is to deposit the scaffold material 214 within the given layer. More particularly, for a first example layer that is to include only the scaffold material 214, the set of layer-by-layer print-paths may include a scaffold-material print-path that defines where the printing unit 220 is to deposit the scaffold material 214 within the first example layer, but not an object-material print-path. Alternatively, for a second example layer that is to include both the object material 212 and the scaffold material 214, the set of layer-by-layer print-paths may include both (i) an object-material print-path that defines where the printing unit 220 is to deposit the object material 212 within the second example layer and (ii) a scaffold-material print-path that defines where the printing unit 220 is to deposit the scaffold material 214 within the second example layer. Alternatively yet, for a third example layer that is to include only the object material 212, the set of layer-by-layer print-paths may include an object-material print-path that defines where the printing unit 220 is to deposit the object material 212 within the third example layer, but not a scaffold-material print-path (although in practice, it may not be desirable or feasible to have a layer that is to be comprised entirely of object material 212).

In other implementations where the disclosed 3D printing system includes more than two material canisters of printing-process materials (e.g., multiple object-material canisters, multiple scaffold-material canisters, and/or one or more material canisters containing one or more types of additional material), then the one or more print-paths for each layer may take other forms as well. For instance, for any given layer, the set of layer-by-layer print-paths could include a (i) zero, one, or multiple object-material print-paths for zero, one, or multiple types of object material to be deposited within the given layer, (ii) zero, one, or multiple scaffold-material print-paths for zero, one, or multiple types of scaffold material to be deposited within the given layer, and (iii) zero, one, or multiple additional-material print-paths for zero, one, or multiple types of additional material to be deposited within the given layer (e.g., a type of additional material that is intended to help facilitate some aspect of the functionality carried out by the 3D printing system 200A such as the sintering process).

In a scenario where certain of the layers have a non-planar top and/or bottom surface, the one or more print-paths for such a layer may also include information about the vertical height of the layer's top and/or bottom surface at different points within the horizontal plane.

The print-paths that define where the printing unit 220 is to deposit the printing-process material(s) may take various other forms as well, including but not limited to the possibility that the print-paths could define an alternate sequence of dispensing operations whereby before filling the entire horizontal plane of the available 3D space within the crucible 225 within a given layer, the printing unit 220 switches to a next layer, dispenses printing-process material on that next layer (e.g., in any portion of the horizontal plane where the given layer was already filled), and then subsequently returns to the given layer to finish filling the printing-process material within that given layer.

In accordance with the present disclosure, the printing unit 220 may comprise various components that work together to carry out the process of dispensing the printing-process materials from the nozzles 218 into the crucible 225.

As shown in FIG. 2, the printing unit 220 may comprise (i) a carriage 222 that is generally configured to hold, move (e.g., in a vertical or Z-dimension), and actuate the individual nozzles 218 during the process of dispensing printing-process materials from the nozzles 218 into the crucible 225, and (ii) a carriage motion system 223 (depicted in dashed lines overlain on the carriage 222) that is generally configured to move the carriage 222 (e.g., in a horizontal or XY-plane) during the process of dispensing printing-process materials from the nozzles 218 into the crucible 225. Each of these printing-unit components may take any of various forms.

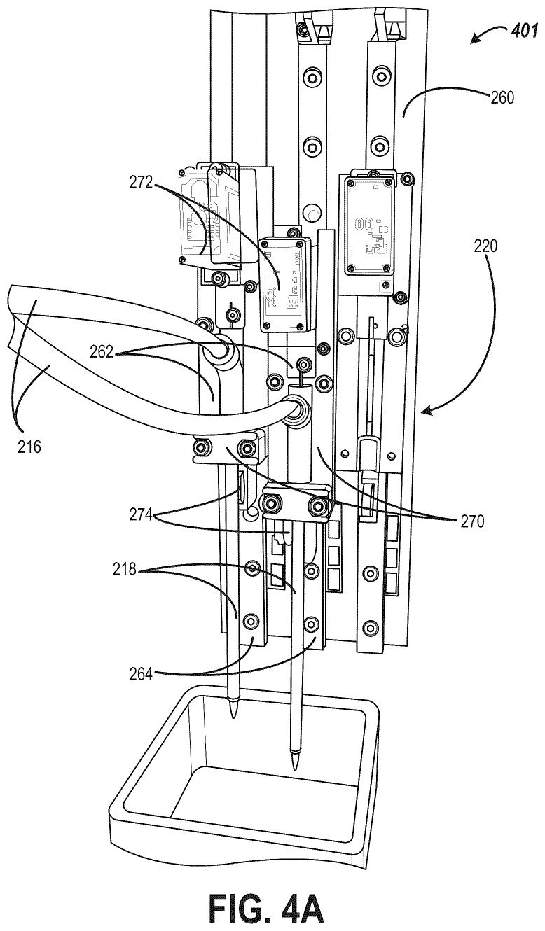

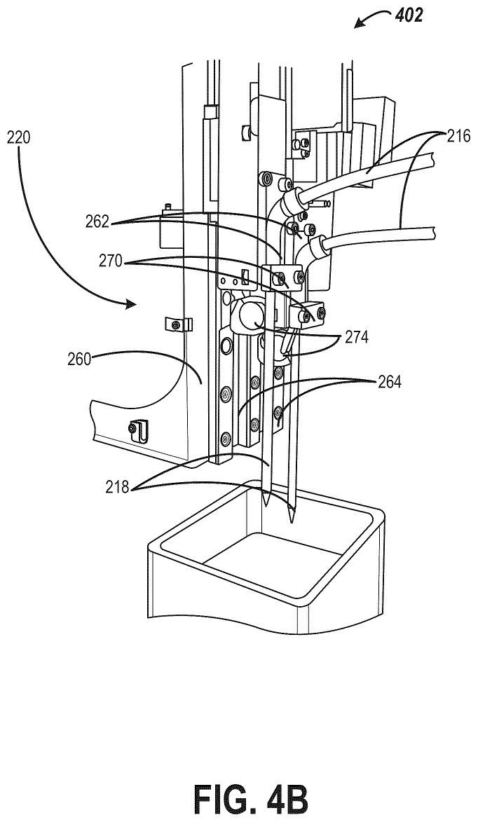

For instance, one possible implementation of the carriage 222 of the printing unit 220 is illustrated in FIGS. 4A-4B, which show a front and side perspective of an example carriage 222. In FIGS. 4A-4B, the example carriage 222 is shown to include (i) a carriage body 260 that serves as a support structure to which the nozzles 218 can be attached, (ii) a set of dispensing units 262 that are each affixed to the carriage body 260 and each configured to hold and actuate a respective nozzle 218, and (iii) a set of dispensing-unit motion systems 264 that are each configured to move an individual one of the dispensing units 262 (and thus an individual one of the nozzles 218) in a vertical or Z-direction relative to the carriage body 260, among other possible components of the example carriage 222. The carriage body 260 that serves as the support structure for the nozzles 218 may take any of various forms. For instance, the carriage body 260 may generally comprising a rigid body of any shape, size, and material that allows for the nozzles 218 to be mounted to the carriage body 260 (via the attached dispensing units 262) and moved vertically relative to the carriage body 260 (via the set of dispensing-unit motion systems 264) while also allowing the carriage 222 as a whole to be moved horizontally by the carriage motion system 223. One possible example of such a carriage body may comprise a rigid body made of metal that has an L-shape, where the exterior surface of the vertical leg of the L-shaped carriage body 260 serves as the mounting surface for the dispensing units 262 (and thus the nozzles 218) and the interior surface of the horizontal leg of the L-shaped carriage body 260 serves as the connection point to the carriage motion system 223. However, the carriage body 260 could take various other forms as well.

Turning next to the dispensing units 262, as noted above, each such dispensing unit 262 may be configured to hold and actuate a respective nozzle 218. In this respect, each of the dispensing units 262 may include any of various components that are configured to help perform these functions, and in FIGS. 4A-4B, each respective dispensing unit 262 is shown to include (i) a mounting unit 270 for mounting a nozzle 218 within the dispensing unit 262, (ii) a material-release actuator 272 that is configured to actuate the nozzle 218 (and more particularly the nozzle's valve stem) in order to control whether the nozzle 218 is in an open or closed state for releasing a printing-process material contained therein, and (iii) a nozzle vibrator 274 that is configured to apply vibration to the nozzle 218 in order to help facilitate the nozzle's release of a printing-process material contained therein by inducing movement of the printing-process material.

In FIGS. 4A-4B, each respective dispensing unit's mounting unit 270 is shown to include a receptacle for a top portion of a nozzle 218 and a mechanical feature (e.g., a fastener such as a screw clamp) for securing the nozzle 218 within the receptacle during mounting of the nozzle 218 and releasing the nozzle 218 from the receptacle during unmounting of the nozzle 218. In this respect, the mechanical feature may serve to affix the nozzle 218 to the dispensing unit 262 in some manner, such that the nozzle 218 moves in tandem with the dispensing unit 262. However, the mounting units 270 could take various other forms as well, including but not limited to the possibility that the mounting units 270 could incorporate any of various other types of mechanical features for affixing the nozzle 218 to the dispensing unit 262 (e.g., a mate, a latch, a magnetic attachment, a snap fitting, etc.)—including but not limited to a type of mechanical feature that is designed to secure the nozzle 218 within the receptacle in a more permanent way (e.g., in a scenario where the nozzles 218 are designed to be built-in components of the 3D printing system 200A).

Further, each respective dispensing unit's material-release actuator 272 is shown to comprise an actuator that is configured to (i) connect to the nozzle's valve stem, which may protrude from the top end the nozzle 218 as discussed above, and (ii) actuate the nozzle's valve stem (under the control of the one or more computing units 240) by moving it up or down so as to toggle the nozzle 218 between an open state for releasing a printing-process material contained therein and a closed state for releasing the printing-process material contained therein. Such material-release actuator 272 may take any of various forms, and in at least some implementations, a material-release actuator 272 may comprise a (i) mechanical feature for attaching the nozzle's valve stem to the material-release actuator 272 during mounting of the nozzle 218 and detaching the nozzle's valve stem from the material-release actuator 272 during unmounting of the nozzle 218 and (ii) a motor (e.g., a servo), a cam system, or the like that functions to move the valve stem up and down under the control of the one or more computing units 240. For instance, in the implementation shown in FIGS. 4A-4B, the mechanical feature of the material-release actuator 272 is shown to take the form of a fastener (e.g., a screw clamp) for securing the nozzle's valve stem within a valve-step receptacle that is molded into the material-release actuator 272. However, the material-release actuators 272 could take various other forms as well, including but not limited to the possibility that the material-release actuators 272 could incorporate any of various other types of mechanical features for attaching the nozzle's valve stem to the material-release actuator 272 (e.g., a mate, a latch, a magnetic attachment, a snap fitting, etc.)—including but not limited to a type of mechanical feature that is designed to attach the nozzle's valve stem to the material-release actuator 272 in a more permanent way (e.g., in a scenario where the nozzles 218 are designed to be built-in components of the 3D printing system 2A).

In the implementation shown in FIGS. 4A-4B, each respective dispensing unit's material-release actuator 272 is shown to be in a position that sits above the respective dispensing unit's mounting unit 270 (and the nozzle 218 mounted therein), but the material-release actuator 272 could be placed in other positions relative to the mounting unit 270 as well.

Further yet, each respective dispensing unit's nozzle vibrator 274 may comprise any type of component that is configured to apply vibration to a nozzle 218 that has been mounted to the dispensing unit 262 (under the control of the one or more computing units 240) in order to induce movement of a printing-process material contained within the nozzle 218 and thereby help to facilitate the nozzle's release of the printing-process material at times when the nozzle 218 is in an open state. In line with the discussion above, such a nozzle vibrator 274 may take any of various forms, examples of which may include a type of vibrating motor (e.g., a brushless or brushed DC motor with an attached eccentric mass, a toothbrush motor of the type found in a sonic or ultrasonic toothbrush, etc. ,), a linear-resonance actuator, or a transducer or coil (e.g., an ultrasonic transducer, voice coil, etc.), among various other possible types of vibrator components. However, the nozzle vibrators 274 could take various other forms as well, including but not limited to the possibility that the individual nozzle vibrators 274 could be combined into a single vibrating system and/or that the nozzle vibrators 274 could each comprise multiple vibrating components that work together to produce the vibration.

In the implementation shown in FIGS. 4A-4B, each respective dispensing unit's nozzle vibrator 274 is shown to be in a position that sits below the respective dispensing unit's mounting unit 270 and is adjacent to where a nozzle 218 will be positioned once mounted within the mounting unit 270, such that when a nozzle 218 is mounted, the nozzle vibrator 274 will be either be in contact with or in close proximity to the nozzle 218 and can the vibration produced by the nozzle vibrator 274 can thereby be applied to the nozzle 218. However, each respective dispensing unit's nozzle vibrator 274 could be placed in various other positions relative to the mounting unit 270 and/or the nozzle 218 as well.

In line with the discussion above, in addition (or perhaps in alternative) to the nozzle vibrators 274, the example 3D printing system 200A may also include material-canister vibrators that are configured to apply vibration to the material canisters 210 and/or feed-line vibrators that are configured to apply vibration to the feed lines 216, where such vibrators are likewise controlled by the one or more computing units 240.

The dispensing units 262 may take various other forms as well, including but not limited to the possibility that the dispensing units 262 may comprise other components that may be useful to hold and/or actuate the nozzles 218.

Referring again to FIGS. 4A-4B, each of the dispensing units 262 may be affixed to the carriage body 260 via a respective dispensing-unit motion system 264 from the set of dispensing-unit motion system 264, which as noted above may each be configured to move an individual one of the dispensing units 262 (and thus an individual one of the nozzles 218) in a vertical or Z-direction relative to the carriage body 260. Each such dispensing-unit motion system 264 make take any of various forms, and in at least some implementations, each dispensing-unit motion system 264 may be a linear motion system that includes one or more linear rails (or “tracks”) that allow for movement in the vertical or Z-direction along with an actuator for moving a dispensing unit 262 along the one or more linear rails (e.g., one or more motors, a ball screw, etc.) under the control of the one or more computing units 240, among other possible components. However, the dispensing-unit motion systems 264 could take various other forms as well, including but not limited to the possibility that the individual dispensing-unit motion systems 264 could be integrated together into one combined dispensing-unit motion system that is capable of moving each of dispensing units 262 (and thus each of the nozzles 218) individually.

The carriage 222 of the printing unit 220 could take various other forms as well, including but not limited to the possibility that the carriage 222 may comprise additional or alternative components to those that are described above.

Returning to FIG. 2A, as introduced above, the printing unit 220 may also comprise the carriage motion system 223, which is generally configured to move the carriage 222 (and thus any installed nozzles 218) in a horizontal or XY-plane during the process of dispensing printing-process materials from the nozzles 218 into the crucible 225. The carriage motion system 223 make take any of various forms, and in at least some implementations, the carriage motion system 223 may be a 2D motion system that includes one or more X-axis rails that allow for movement of the carriage 222 in a first horizontal direction, one or more Y-axis rails that allow for movement of the carriage 222 in a second horizontal direction, and an actuator for moving the carriage 222 along the X-axis and Y-axis rails (e.g., one or more motors, one or more ball screws, one or more belts, etc.) under the control of the one or more computing units 240, among other possible components. This type of 2D motion system is sometimes referred to as an “XY gantry.” However, the carriage motion system 223 could take various other forms as well, including but not limited to the possibility that the carriage motion system 223 could include multiple individual systems that work together to move the carriage 222 in a horizontal or XY-plane.

In the example configuration of the printing unit 220 described above, the functionality that is carried out by the printing unit 220 (under the control of the one or more computing units 240) in order to dispense a printing-process material from a given nozzle 218 that is mounted to a given dispensing unit may generally involve (i) using a dispensing-unit motion system 264 for the given dispensing unit 262 to vertically move the given dispensing unit 262 down until the given nozzle's bottom end is at a dispensing height that corresponds to the top of the next layer of printing-process material(s) that is to be deposited within the crucible 225, (ii) using the material-release actuator 272 of the given dispensing unit 262 to raise the valve stem of the given nozzle 218 and thereby place the given nozzle 218 into an open state for releasing the printing-process material contained therein, (iii) optionally using the nozzle vibrator 274 of the given dispensing unit 262 to apply vibration to the given nozzle 218 to help facilitate the given nozzle's release of the printing-process material (perhaps while a material-canister vibrator is applying vibration to the corresponding material canister 210 and/or a feed-line vibrator is applying vibration to the corresponding feed line 216), and (iv) using the carriage motion system 223 to move the carriage 222 and thus the given nozzle 218 within the horizontal plane in accordance with the material's print-path for the next layer while the given nozzle 218 releases the printing-process material from the dispensing height that corresponds to the top of the next layer of printing-process material(s) that is to be deposited. In this respect, it will be appreciated that once the area underneath the given nozzle 218 at any particular horizontal position has been filled up to the dispensing height with the printing-process material, the given nozzle 218 will be prevented from releasing additional printing-process material until the given nozzle 218 is moved to a new horizontal position. To the extent that the next layer of printing-process material(s) to be deposited includes multiple types of printing-process materials, the printing unit 220 may then repeat this functionality for each additional type of printing-process material that is to be deposited in the next layer. And in turn, the printing unit 220 may perform this functionality for each of the other layers of printing-process material(s) to be deposited.

Notably, the disclosed approach of moving the nozzles 218 (both vertically and horizontally) relative to the crucible 225 rather than moving the crucible 225 relative to the nozzles 218 may provide various advantages over other 3D printing systems that move the crucible 225 during the printing process, including that (i) the disclosed approach avoids the need for a cylinder and a Z-piston, which may reduce the complexity (and thus the likelihood of malfunction) of the 3D printing system as well as the cost of the 3D printing system, and (ii) the disclosed approach eliminates (or at least minimizes) the risk that the printing-process material contained within the crucible 225 might shift and/or displace during the printing process because the crucible 225 is fixed in place rather than in motion as in other 3D printing systems, which avoids the adverse effects on the 3D object's geometry that could result from such shifting and/or displacement of the printing-process material within the crucible 225.

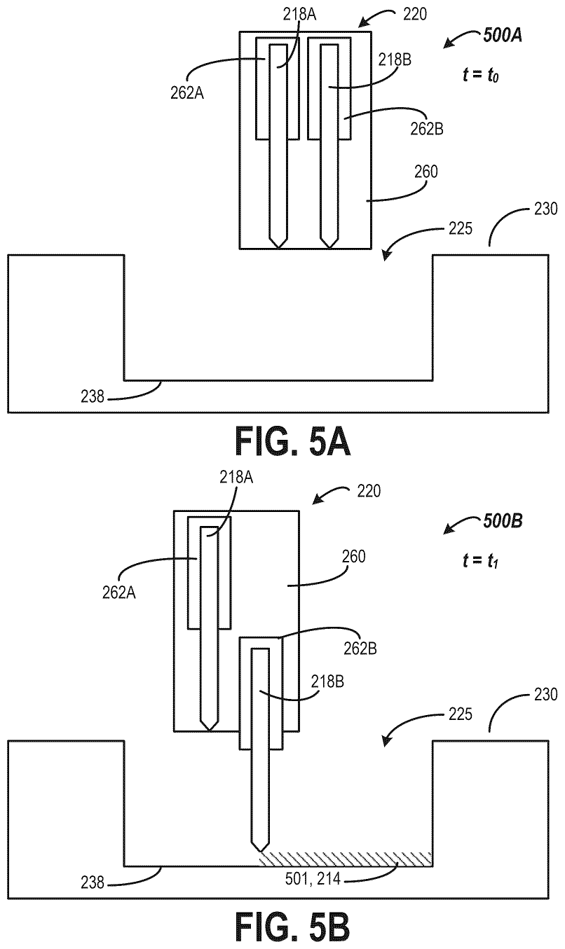

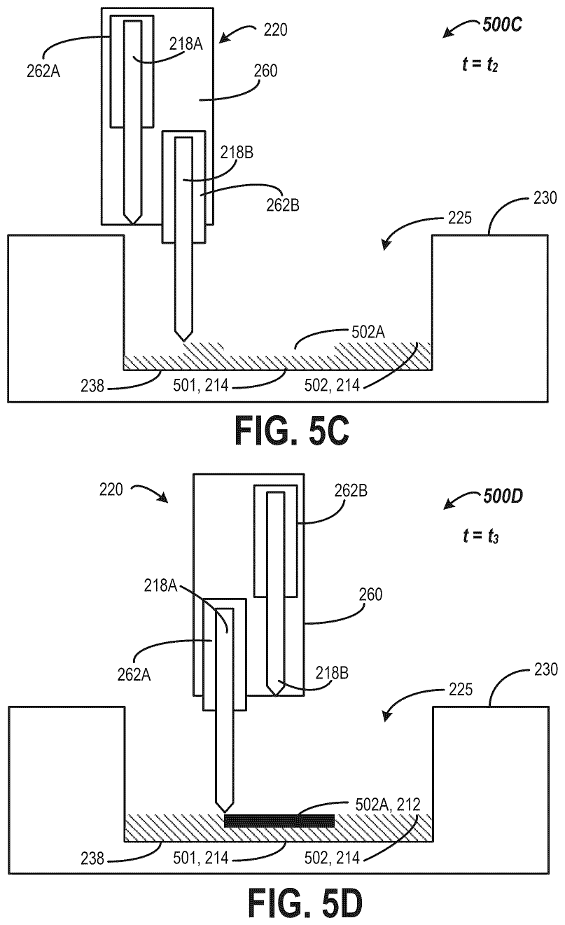

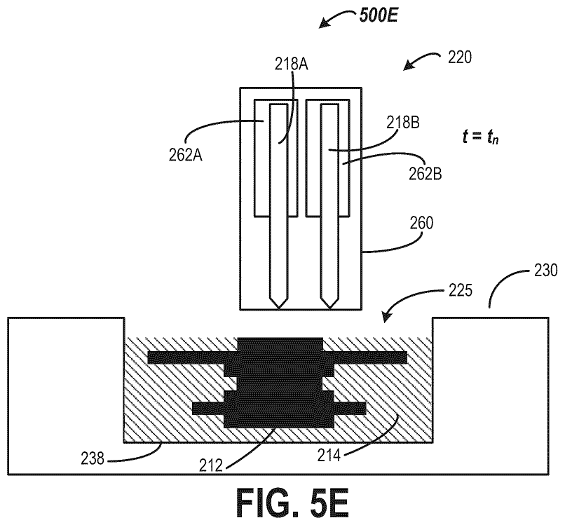

The functionality that is carried out by the printing unit 220 during the process of dispensing printing-process materials from the nozzles 218 into the crucible 225 is described in further detail below with reference to FIGS. 5A-5E.

Returning again to FIG. 2A, the crucible 225 generally comprises any type of volume-holding container (or “vessel”) within which the layers of printing-process material(s) may be (i) deposited into by the printing unit 220 and, subsequently, (ii) heated by the furnace 230 (e.g., by having at least one of its surfaces subjected to heat). In this respect, the crucible 225 may comprise any type of volume-holding container that is capable of being filled with the layers of printing-process material(s) and then maintaining its structure while being heated by the furnace 230 (e.g., a type of volume-holding container that is capable of withstanding the relatively high temperatures needed to sinter the object material 212). For example, the crucible 225 may comprise a volume-holding container that is made from a heat-resistant material such as ceramic, among other possibilities.

In at least some implementations, the crucible 225 may be a separate component from the furnace 230 that can be selectively placed within or removed from the furnace 230. And in such implantations, it is possible that the furnace 230 could be designed to accommodate crucibles having any of various different shapes and/or sizes, which may allow a user to utilize different crucibles 225 for different 3D objects (e.g., crucibles with larger available 3D space for larger 3D objects and crucibles with smaller 3D space for smaller 3D objects so as to reduce the amount of scaffold material 214 for such smaller 3D objects and, thereby, also possibly reduce the amount of time needed to create such smaller 3D objects). Notably, this ability for a user to switch between different crucibles 225 is made possible by the fact that the disclosed 3D printing system is designed to move the nozzles 218 relative to the crucible 225 rather than being designed to move the crucible 225 itself (which is how many existing 3D printing systems work).

Alternatively, in other implementations, the crucible 225 may be integrated together with (or a component defined by structures of) the furnace 230. And in such implementations, the integrated crucible 225 could have any of various shapes and/or sizes, although in practice, the shape and size of the integrated crucible 225 would preferably be suitable for accommodating 3D objects of many different shapes and sizes.

The crucible 225 may take any of various other forms, as well.

Turning next to the furnace 230, at a high level, the furnace 230 may comprise any type of furnace structure that is capable of heating the crucible 225 and in turn the contents thereof, which may include the deposited object material 212 and the deposited scaffold material 214, to a temperature at which the object material 212 will sinter and thereby fuse together to produce the 3D object being created.

For instance, the furnace 230 may comprise one or more heating elements (e.g., a gas burner, an electric heat source, etc.) that apply heat to at least one surface of the crucible 225, which in turn transfers the heat to the printing-process material contained within the crucible 225. In this respect, the furnace 230 may heat the crucible 225 to a temperature level at which the object materials 212 contained within the crucible 225 are expected to sinter and fuse together to produce the sintered object material 212 that makes up the 3D object being created—which may comprise a temperature level that is at or above the sintering temperature of the object material 212.

Additionally, although not specifically shown in FIG. 2A, the furnace 230 may comprise one or more structural elements that surround the heated zone around the crucible 225 and serve to prevent excess heat for emanating outside of the 3D printing system 200A. For example, the furnace 230 may comprise at least one insulator layer that surrounds the heated zone around the crucible 225, such that excess heat does not unnecessarily emanate outside of the 3D printing system 200A, and perhaps also another structural layer outside of such an insulator layer that serves as a safety shell for the furnace 230, thereby further preventing heat from unnecessarily emanating outside of the 3D printing system 200A. While the insulator layer may comprise a material that provides insulation to prevent heat from unnecessarily emanating outside of the 3D printing system 200A, it is contemplated that the insulating layer may comprise a void, absent materials, between the crucible 225 and an outside wall of the 3D printing system 200A. In such an example, the insulating layer may take the form of an air gap between the furnace and the outer surface that prevents at least some heat from transferring to the outside wall of the 3D printing system 200A. The insulating layer may take various other forms, as well.

Additionally yet, the furnace 230 may comprise a furnace lid 237 that is configured to cover the crucible 225 during heating of the crucible 225 and the contents therein. In FIG. 2A, the furnace lid 237 is shown to be in a retracted position within a sidewall 239 of the crucible 225, which may be the position of the furnace lid 237 during the process of dispensing the object and scaffold materials into the crucible 225, and the furnace lid 237 may then subsequently extrude from the sidewall 239 to cover the open space of the crucible 225 prior to heating the crucible 225 and its contents. In this respect, the furnace lid 237 may be moved from a retracted position to an extruded position (or vice versa) via one or more actuators that are controlled by the one or more computing units 240. However, the furnace lid 237 may cover (or be positioned to cover) the crucible 225 in any of various other ways (e.g., positioning the furnace lid 237 from above the crucible 225, extruding the furnace lid 237 from another sidewall of the crucible, etc.). Movement of the furnace lid 237 may be performed via one or more actuators that move the furnace lid 237 in response to instructions from one or more computing unit(s) 240.

The furnace 230 may take various other forms as well, including but not limited to the possibility that the furnace 230 may include other components for heating the crucible 225 and/or mitigating excess heat.

Referring again to FIG. 2A, the one or more computing units 240 of the example 3D printing system 200A may function to control the operation of the 3D printing system 200A. For instance, in line with the discussion above, the one or more computing units 240 may function to control (i) the printing unit 220 and the sub-components thereof (e.g., the dispensing-unit motion systems 264, the material-release actuators 272, the vibrators 274, and the carriage motion system 223), and (ii) the furnace 230 along with its associated furnace lid 237, and (iii) any additional vibrators that are included within the 3D printing system 200A (e.g., material-canister and/or feed-line vibrators), among other aspects of the 3D printing system 200A that may be controlled by the one or more computing units 240. Further, in operation, the one or more computing units 240 may control the operation of a given component (or sub-component) of the 3D printing system 200A by generating control signals for operating the given component (or sub-component) and then sending those control signals to the given component via a respective communication path, which may take the form of a wired or wireless communication link between the one or more computing units 240 and the given component (or sub-component) (e.g., a system bus, a serial or Ethernet cable, a point-to-point wireless link, etc.). In this respect, depending on the type of component (or sub-component) being controlled, the control signals that are generated for and sent to each respective component (or sub-component) could comprise either analog control signals (e.g., continuous signals having a varying voltage or current) or digital control signals (e.g., on/off signals, high/low signals, signals sent according to a defined digital communication protocol, etc.).

Further, the one or more computing units 240 of the example 3D printing system 200A may additionally function to communicate with other external devices. For instance, the one or more computing units 240 may function to communicate with a client device that is installed with software for interacting with and/or controlling the example 3D printing system 200A, one example of which is shown in FIG. 2A as client device 202, over a respective communication path that may comprise a wired or wireless communication network (e.g., an Ethernet network, a Wi-Fi network, a cellular network, a Bluetooth network etc.), a wired or wireless communications link (e.g., a serial or Ethernet cable, a point-to-point wireless link, etc.), or a combination thereof.

Further yet, if the example 3D printing system 200A includes an I/O interface (e.g., the touchscreen 130 of FIG. 1), the one or more computing units 240 of the example 3D printing system 200A may additionally function to interact with and drive the I/O interface.

The one or more computing units 240 of the example 3D printing system 200A may perform other functions as well.

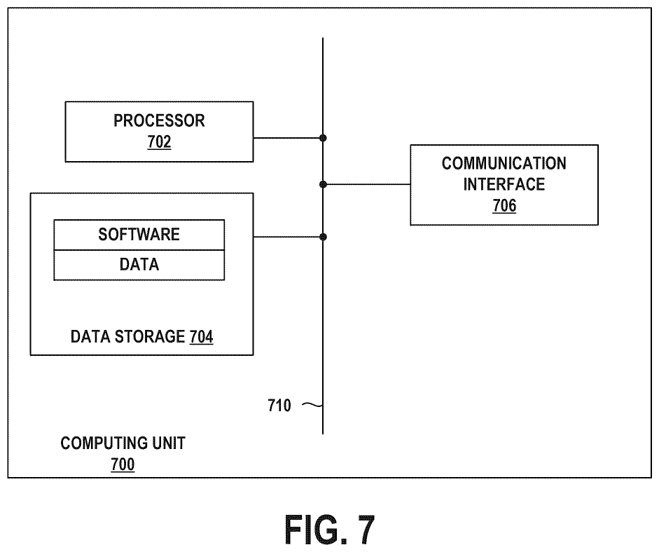

Structurally speaking, each computing unit 240 may generally comprise (i) at least one processor, (ii) data storage comprising at least one non-transitory machine-readable medium, (iii) program code stored in the data storage that is executable by the at least one processor to cause the computing unit 240 to perform the computer-based functions disclosed herein, and (iv) at least one communication interface that facilitates communication with the other components (and/or sub-components) of the example 3D printing system 200A, other devices that are external to the example 3D printing system 200A, and/or an I/O interface of the of the example 3D printing system 200A. Additional details regarding the structure of the one or more computing units 240 are described below with respect to FIG. 7.

Further, depending on the implementation of the example 3D printing system 200A, the one or more computing units 240 may comprise either one single computing unit 240 that is tasked with performing all of the computer-based functions of the example 3D printing system 200A, or multiple computing units 240 that are communicatively coupled via a communication path (e.g., a wired or wireless link) and are each tasked with performing a respective subset of the computer-based functions of the example 3D printing system 200A.

For instance, in an implementation where the one or more computing units 240 comprise one single computing unit 240 that is tasked with performing all of the computer-based functionality of the example 3D printing system 200A, that single computing unit 240 may take the form of a general-purpose computing unit (e.g., a computer running an operating system such as Linux, Microsoft Windows, or Apple macOS) that is installed with program code for performing all of the computer-based functions of the example 3D printing system 200A, including all of the functions related to controlling the other components (and/or sub-components) of the example 3D printing system 200A.

Alternatively, in an implementation where the one or more computing units 240 comprise multiple computing units 240, those multiple computing units may include (i) a general-purpose computing unit (e.g., a computer running an operating system such as Linux, Microsoft Windows, or Apple macOS) that is installed with program code for performing a first subset of the computer-based functions of the example 3D printing system 200A, and (ii) one or more specific-purpose computing units (e.g., microcontrollers or the like) that are each installed with program code for performing a respective subset of the computer-based functions of the example 3D printing system 200A. For example, in such an implementation, (i) the general-purpose computing unit may be programmed to perform functions related to communicating with external devices, interacting with an I/O interface of the example 3D printing system 200A, and providing the one or more specific-purpose computing units with instructions for operating the components (and/or sub-components) of the example 3D printing system 200A (e.g., the set of layer-by-layer print paths), and (ii) each of the one or more specific-purpose computing units may be programmed to perform functions related to controlling a given component (or perhaps multiple given components) of the example 3D printing system 200A, such as by translating the operational instructions for the given component that are received from the general-purpose computing unit into signals for controlling the given component and then sending the signals to the given component so as to instruct and cause the given component to operate in the manner outlined by the general-purpose computing unit.

The particular architecture of the one or more computing units 240 may take various other forms as well, including but not limited to the possibility that other types of computing units may be utilized beyond those discussed above and/or that certain of the one or more computing units 240 may be integrated in whole or in part with other components of the example 3D printing system 200A.

Further, while each of the one or more computing units 240 is shown to be an internal component of the 3D printing system 200A (i.e., an “on-board” computing unit of the system), in other implementations, it is possible either that (i) each of the one or more computing units 240 of the 3D printing system 200A is external to the 3D printing system 200A (i.e., an “off-board” computing unit of the system) or (ii) the one or more computing units 240 comprise a combination of at least one computing unit 240 that is internal to the 3D printing system 200A and at least one computing unit 240 that is external to the 3D printing system 200A, among other possible implementations of the one or more computing units 240. In this respect, if at least one computing unit 240 is external to the 3D printing system 200A, then the housing of the 3D printing system 200A may include an interface for connecting the external computing unit 240 to the one or more of the internal components of the 3D printing system 200A.

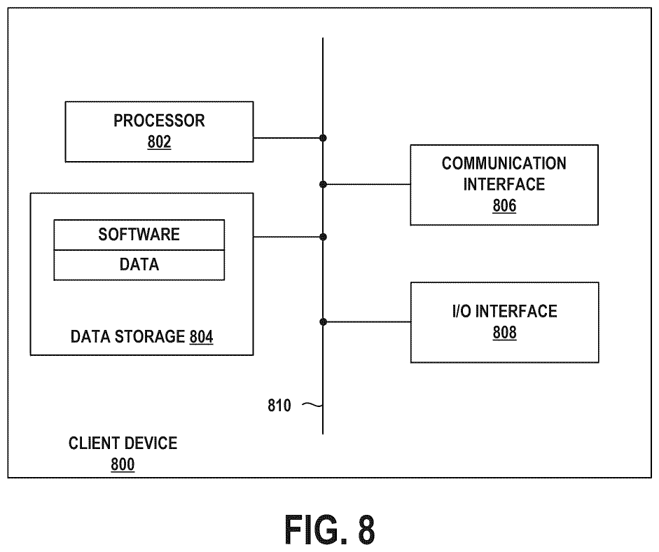

Still referring to FIG. 2A, the client device 202 may generally comprise any type of client device that is capable of running software for interacting with the example 3D printing system. Some representative examples of the client device 202 may include a desktop computer, a laptop, a netbook, a tablet, a smartphone, a spatial computer, or a personal digital assistant (PDA)-each of which may include at least one processor, data storage comprising at least one non-transitory computer-readable medium, program code stored in the data storage that is executable by the at least one processor, at least one communication interface, and at least one I/O interface, among other possible components of a client device. Additional details regarding the structure of a client device are described below with respect to FIG. 8.

Further, the software for interacting with the example 3D printing system may generally take the form of one or more software applications (e.g., native applications, web applications, etc.) that perform functions related to the operation of the example 3D printing system, where each such software application could comprise a native application, a client-server application (e.g., a web application or the like) comprising client-side software that runs on client devices and server-side software that runs on a remote server, or a hybrid application.

For instance, as one possibility, the software for interacting with the example 3D printing system may perform functions related to (i) transforming a model of a 3D object to be created (e.g., a CAD model) into a set of configuration data for the 3D object that can be interpreted and utilized by the one or more computing units 240 of the example 3D printing system 200A to control the printing of the 3D object, and then (ii) transmitting the set of configuration data for the 3D object (and/or the a 3D object model itself) to the example 3D printing system. In this respect, the set of configuration data for the 3D object that is transmitted to the example 3D printing system 200A may include the set of layer-by-layer print-paths described above or may include other configuration data from which the one or more computing units 240 of the example 3D printing system 200A generates the set of layer-by-layer print-paths. Further, in practice, the set of configuration data for the 3D object may be transmitted by the client device 202 itself (via a communication path between the client device 202 and the 3D printing system 200A) or by a remote server that is in communication with the client device 202 (via a communication path between the remote sever and the 3D printing system 200A), among other possible examples.

As another possibility, the software for interacting with the example 3D printing system may perform functions related to (i) presenting a user with a user interface that enables the user to interact with the example 3D printing system 200A, (ii) receiving, via the user interface, user input related to the operation of the example 3D printing system 200A, (iii) transmitting the user input to the example 3D printing system 200A, (iv) receiving, from the example 3D printing system 200A, information regarding the configuration and/or operational status of the example 3D printing system 200A, and (v) presenting, via the user interface, information regarding the configuration and/or operational status of the example 3D printing system 200A. In this respect, the functions of transmitting user input to the example 3D printing system 200A and receiving information from the example 3D printing system 200A may be carried out by the client device 202 itself (via a communication path between the client device 202 and the 3D printing system 200A) or by a remote server that is in communication with the client device 202 (via a communication path between the remote server and the 3D printing system 200A), among other possible examples.

The functions that may be performed by the software for interacting with the example 3D printing system 200A may take other forms as well. Further, it is also possible that some or all of the functionality discussed above may be performed by the one or more computing units 240 of the 3D printing system 200A rather than by the client device 202 or a remote server in communication with the client device 202.

One specific example of the software for interacting with the 3D printing system 200A may comprise a software application referred to as a “slicer” application, which may function to receive a model for a 3D object to be created and then transform the model into a set of configuration data for the 3D object by (i) decomposing the model into a set of sub-sections (or “slices”) of the model, which may correspond to the layers of the printing process discussed above, (ii) generate, for each sub-section of the model, a corresponding subset of configuration data that may comprise object-material and/or scaffold-material print-paths for a respective layer of the print process, and then (iii) compile the respective subsets of configuration data into the set of configuration data to be transmitted to the 3D printing system 200A, which may comprise the set of layer-by-layer print-paths discussed above. However, in other implementations, it is possible that some of all of this functionality may be performed by the one or more computing units 240 of the 3D printing system 200A rather than by the client device 202 or a remote server in communication with the client device 202.

The software for interacting with the 3D printing system 200A may take various other forms and may provide various other functionality as well.

In a scenario where the client device 202 itself communicates with the 3D printing system 200A, that communication may take place over a communication path that may comprise one or more communication networks, one or more communications links, or a combination thereof. For instance, such a communication path between the client device 202 and the 3D printing system 200A may include any one or more of a Personal Area Network (PAN) such as a Bluetooth network, a Local-Area Network (LAN) such as a Wi-Fi network, a Wide-Area Network (WAN) such as the Internet or a cellular network, a cloud network, and/or a point-to-point link, among other possibilities. Further, the communication network(s) and/or link(s) that make up the communication path between the client device 202 and the 3D printing system 200A may be wired, wireless, or some combination thereof, and may carry data according to any of various different communication protocols. Further yet, communications over the communication path could be carried out via an Application Programming Interface (API), among other possibilities. Still further, although not shown, the communication paths between the client device 202 and the 3D printing system 200A may also include one or more intermediate systems. The communication path between the client device 202 and the 3D printing system 200A may take other forms as well.

Along similar lines, in a scenario where the client device 202 communicates with a remote server (e.g., a back-end server in the cloud that drives a client-server application) that in turn communicates with the 3D printing system 200A, that communication between the remote server and the 3D printing system 200A may take place over a communication path that may comprise one or more communication networks, one or more communications links, or a combination thereof. For instance, such a communication path between the remote server and the 3D printing system 200A may include any one or more of a PAN such as a Bluetooth network, a LAN such as a Wi-Fi network, a WAN such as the Internet or a cellular network, a cloud network, and/or a point-to-point link, among other possibilities. Further, the communication network(s) and/or link(s) that make up the communication path between the remote server and the 3D printing system 200A may be wired, wireless, or some combination thereof, and may carry data according to any of various different communication protocols. Further yet, communications over the communication path could be carried out via an API, among other possibilities. Still further, although not shown, the communication paths between the remote server and the 3D printing system 200A may also include one or more intermediate systems. The communication path between the remote server and the 3D printing system 200A may take other forms as well.

The 3D printing system 200A may be configured to communicate with other external systems over other communication paths as well.

The functionality of the printing unit 220 of the example 3D printing system 200A will now be described in further detail with reference to FIGS. 5A-5E, each of which illustrates a side view of the two nozzles 218A, 218B, the printing unit 220 (which comprises two dispensing units 262A, 262B that are holding the two nozzles 218A, 218B), the crucible 225, and the furnace 230 at a different example time during the process of depositing the layers of printing-process material(s) from the nozzles 218 into the crucible 225. It should be understood that these example views are provided for the purpose of illustration and explanation, and the specific form of the layers is not intended to indicate the generation of any specific object or associated scaffold. Rather, the 3D printing technology disclosed herein can be utilized to form any objects of any of various forms, while also depositing the scaffold materials in negative space proximate to the portions of the object, to assist in creating the object.

Beginning with FIG. 5A, a first side view 500A of the nozzles 218, the printing unit 220, the crucible 225, and the furnace 230 is illustrated at an initial time (“t=t₀”) in advance of material deposition for any of the layers of printing-process material(s). For example, t₀ may be any point in time prior to when the printing unit 220 deposits a first layer of printing-process material(s). In this example (and in the subsequent views at later points in time), the printing unit 220 may function to deposit layers of printing-process material(s), in succession, starting with a first layer that is deposited on a bottom surface 238 of the crucible 225.

Next, FIG. 5B illustrates a second side view 500B of the nozzles 218, the printing unit 220, the crucible 225, and the furnace 230 at a subsequent point in time (“t₁”) after the initial time t₀. In FIG. 5B, the second nozzle 218B (which as noted above is configured to dispense the scaffold material 214) is shown to be releasing the scaffold material 214 (in part, as shown) for a first layer 401. To accomplish this, the printing unit 220 may function to (i) vertically move the second dispensing unit 262B down until the second nozzle's bottom end is at a dispensing height that corresponds to the top of the first layer 501, (ii) raise the valve stem of the second nozzle 218B and thereby place the second nozzle 218B into an open state for releasing the scaffold material 214 contained therein, (iii) optionally apply vibration to the second nozzle 218B to help facilitate the second nozzle's release of the scaffold material 214 (perhaps while vibration is also being applied to one or both of the second material canister 210B and/or the second feed line 216B), and (iv) move the carriage 222 and thus the second nozzle 218B within a horizontal plane while the second nozzle 218B releases the scaffold material 214 from the dispensing height that corresponds to the top of the first layer 501. In line with the discussion above, the one or more computing units 240 may control the printing unit 220 to operate in this manner in accordance with a scaffold-material print-path for the first layer 501.

In the example of FIG. 5B, the first layer 501 being deposited is comprised entirely of the scaffold material 214, which may serve then serve as a support “base” for the object material 212 that is deposited within subsequent layers that sit atop the first layer 501. However, it is also possible that the first layer 501 could include more than one type of printing-process material.

Next, FIG. 5C shows a third side view 500C of the nozzles 218, the printing unit 220, the crucible 225, and the furnace 230 at a subsequent point in time (“t₂”) after the prior time t₁. In FIG. 5C, the second nozzle 218B is shown to be releasing the scaffold material 214 (in part, as shown) for a second layer 502. To accomplish this, the printing unit 220 may function to (i) vertically move the second dispensing unit 262B down until the second nozzle's bottom end is at a dispensing height that corresponds to the top of the second layer 502, (ii) raise the valve stem of the second nozzle 218B and thereby place the second nozzle 218B into an open state for releasing the scaffold material 214 contained therein, (iii) optionally apply vibration to the second nozzle 218B to help facilitate the second nozzle's release of the scaffold material 214 (perhaps while vibration is also being applied to one or both of the second material canister 210B and/or the second feed line 216B), and (iv) move the carriage 222 and thus the second nozzle 218B within a horizontal plane while the second nozzle 218B releases the scaffold material 214 from the dispensing height that corresponds to the top of the second layer 502. In line with the discussion above, the one or more computing units 240 may control the printing unit 220 to operate in this manner in accordance with a scaffold-material print-path for the second layer 502.

FIG. 5C further shows that there is a void 502A between deposition areas of the scaffold material 214 for the second layer 502, which may represent a deposition area that is be filled with the object material 212 rather than the scaffold material 214. In other words, the scaffold-material print-path for the second layer 402 may not include a deposition area within the void 502A.

Next, FIG. 5D shows a fourth side view 500D of the nozzles 218, the printing unit 220, the crucible 225, and the furnace 230 at a subsequent point in time (“t₃”) after the prior time t₂. In FIG. 5D, the first nozzle 218A (which as noted above is configured to dispense the object material 212) is shown to be releasing the object material 212 for the second layer 502. To accomplish this, the printing unit 220 may function to (i) vertically move the first dispensing unit 262A down until the first nozzle's bottom end is at a dispensing height that corresponds to the top of the second layer 502, (ii) raise the valve stem of the first nozzle 218A and thereby place the first nozzle 218A into an open state for releasing the object material 212 contained therein, (iii) optionally apply vibration to the first nozzle 218A to help facilitate the first nozzle's release of the object material 212 (perhaps while vibration is also being applied to one or both of the first material canister 210A and/or the first feed line 216A), and (iv) move the carriage 222 and thus the first nozzle 218A within a horizontal plane while the first nozzle 218A releases the object material 212 from the dispensing height that corresponds to the top of the second layer 502. In line with the discussion above, the one or more computing units 240 may control the printing unit 220 to operate in this manner in accordance with an object-material print-path for the second layer 502.

FIG. 5D further shows that the object material 212 for the second layer 502 has been deposited within the void 502A that was left during the depositing of the scaffold material 214 for the second layer 502. In this respect, while FIG. 5D shows an example where the object material 212 is deposited within a single void 502A, it should be understood that a given layer could include multiple voids within the deposited scaffold material 214 that are to be filled with object material 212. Further, while FIGS. 5C and 5D show an example where the scaffold material 214 for the layer is deposited first and the object material 212 for the layer is deposited second, it should be understood that the order of these operations could be reversed such that the object material 212 is deposited first (with one or more voids) and the scaffold material 214 for the layer is deposited second. And along similar lines, for any given layer, it is also possible that the printing unit 220 could engage in multiple instances of dispensing a particular type of printing-process material, such as multiple instances of dispensing the scaffold material 214 and/or multiple instances of dispensing the object material 212, where such multiple instances could likewise be sequenced in any of various manners. Further yet, while the void 502A in the second layer 502 is shown in a single dimension of the horizontal plane, it should be understood that the one or more voids will extend into both horizontal dimensions of the crucible 225. Still further, while the second layer 502 is shown to be comprised of two types of printing-process materials—the object material 212 and the scaffold material 214—it should be understood that the second layer 502 could be comprised of more than two types of printing-process materials (in which case the dispensing of the more than two types of printing-process materials could follow any possible sequence).

After depositing the scaffold material 214 and the object material 212 of the second layer 402 in the manner described above, the printing unit 220 may carry out functionality similar to that of FIGS. 5C and 5D for each of the subsequent layers of printing-process material(s) to be deposited. More particularly, for each of the subsequent layers of printing-process material(s) to be deposited, the printing unit 220 may function to deposit the scaffold material 214 for the layer in accordance with the scaffold-material print-path for the layer (if any) and deposit the object material 212 for the layer in accordance with the object-material print-path for the layer (if any).

FIG. 5E shows a fifth side view 500E of the nozzles 218, the printing unit 220, the crucible 225, and the furnace 230 at a point in time (“tₙ”) after this functionality has been carried out and all of the layers have been deposited. As shown in FIG. 5E, the crucible 225 contains a total of 8 layers, where the first layer 501 comprises only the scaffold material 214 and each of the other seven layers each comprise both the scaffold material 214 and the object material 212. These eight layers of material collectively form a build in which the scaffold material 214 occupies the negative space proximate to the object material 212 and can serve as a scaffold or support mechanism for the object material 212 within the crucible 225.

The functionality for dispensing the printing-process materials into the crucible 225 could take various other forms as well. For example, instead of dispensing the printing-process materials for a layer on a material-by-material basis where there is only one type of printing-process material being dispensed from one specific nozzle 218 at any given time, it is possible that the printing unit 220 could function to dispense multiple types of printing-process material from multiple nozzles 218 at the same time. As another example, it is possible that the printing unit 220 could switch to dispensing printing-process material within a next layer before fully filling a given layer and could then return to the given layer to finish dispensing printing-process material within that given layer. As another example, it is possible that certain of the layers of printing-process material dispensed by the printing unit 220 have non-planar top and/or bottom surfaces. Other variations of the functionality for dispensing the printing-process materials into the crucible 225 are possible as well.

After the build comprising the layers of printing-process material(s) has been completed, the one or more computing units 240 may then instruct and cause the furnace 230 to heat the crucible 225 and the contents therein to a temperature that is at or above the sintering point for the object material 212. During this heating, the object material 212 within the crucible will sinter and fuse together in order to produce the final 3D object, and the scaffold material 214 will continue to serve as a scaffold or support mechanism for the object material 212 during the sintering process.

After heating the build comprising the object material 212 and the scaffold material 214 in the crucible 225, the build comprising the now-sintered object material 212 and the surrounding scaffold material 214 may thereafter be cooled. Such cooling of the build comprising the sintered object material 212 and the scaffold material 214 may be performed in a passive manner, such as by allowing the build comprising the sintered object material 212 and the scaffold material 214 to cool naturally (e.g., by turning down a temperature level of the furnace 230, by turning off the heating element(s) of the furnace 230, by opening the furnace lid 237 to (i) allow outside, cooler air to enter the crucible 225 and/or (ii) allow heat from inside the crucible 225 to emanate out of the crucible 225 and into the outside environment, etc.). Additionally or alternatively, one or more active cooling components (not shown) may be utilized to assist in cooling the build comprising the sintered object material 212 and the scaffold material 214 (e.g., using one or more fans to move one or both of (i) heat away from the build and/or (ii) cooler air towards the build, using one or more liquid cooling components that pump a liquid within a structure (e.g., one or more heat pipes) to transfer heat from the crucible 225 to a heatsink, etc.). Cooling of the build comprising the sintered object material 212 and the scaffold material 214 may take various other forms as well.

After the build comprising the sintered object material 212 and the scaffold material 214 has been cooled, the scaffold material 214 may thereafter be separated from the sintered object material 212 via a finishing process such as tumbling, media blasting, or the like. In this respect, the finishing process may take place within the 3D printing system 200 itself (e.g., a finishing mechanism that is integrated with the crucible 225 and/or furnace 230) or may take place within a separate machine (e.g., a tumbling or blasting machine), among other possibilities. In either case, the finishing process may involve applying any one or more finishing techniques for causing the scaffold material 214 to be separated from the sintered object material 212, including but not limited to tumbling techniques (e.g., rotating or shaking the build within a drum) and/or media-blasting techniques. During this finishing process, if the scaffold material 214 is of a type that has an abrasive texture as discussed above, then the scaffold material 214 may also serve to polish, smooth, debur, and/or clean the sintered object material 212, which may eliminate (or at least reduce) the need to separately perform these tasks either during or after the finishing process.

Several extensions and/or variations of the example 3D printing system 200A that is shown and described with reference to FIGS. 2A, 3A-3B, 4A-4B, and 5A-5E are possible as well.

As one possible variation and/or extension, the example 3D printing system 200A may be adapted to include and dispense material from more than two material canisters. For instance, instead of having two material canisters as in the example 3D printing system 200A described above with reference to FIG. 2A, a 3D printing system designed in accordance with the present disclosure could include three or more material canisters, where each additional material canister could comprise either (i) another type of object material from which the 3D object is to be created, (ii) another type of scaffold material, or (iii) a type of additional material that may help to improve the printing process in some way (e.g., a chemically-reducing material, a lubricating material, a material that serves as a shield against air/oxygen influx, etc.).

One possible example of the internal architecture of an example 3D printing system 200B that includes more than two material canisters is shown in FIG. 2B, which includes many like elements to those of the internal architecture of FIG. 2A. The descriptions of such like elements (having the same reference numbers) that are discussed above with respect to FIG. 2A also are descriptive of these elements in FIG. 2B.

As shown in FIG. 2B, in addition to the first and second material canisters 210A, 210B and their corresponding feed lines 216A, 216B and nozzles 218A, 218B, the internal architecture of the 3D printing system 200B comprises one or more additional material canisters 210C-N along with one or more corresponding feed lines 216C-N and one or more nozzles 218C-N, where each such additional material canister 210C-N may contain (i) another type of object material 212, (ii) another type of scaffold material 214, or (iii) a type of additional material that may help to improve the printing process in some way. This flexibility to include three or more material canisters may advantageously provide users with the ability to print more complex parts by introducing multiple object materials, multiple scaffold materials, or other additive materials into the printing process.

As another possible variation and/or extension, the example 3D printing system 200A could further include a camera that is configured to record images of the contents of the crucible during the process of dispensing the material within the crucible, and those images may then be transmitted to the one or more computing units for analysis. For instance, after each layer of print-process material(s) is deposited by the printing unit 220 of the example 3D printing system 200A, the camera may function to record an image of the contents of the crucible 225 and then transmit that image to the one or more computing units 240, which may then analyze the image in order to determine whether the layer has been deposited properly. The image-analysis functionality may take any of various forms.

For instance, as one possibility, the one or more computing units 240 may (i) utilize one or more image processing techniques (e.g., a computer vision technique) to determine which portions of a given layer appear to be object material 212 and which portions of the given layer appear to be scaffold material 214, (ii) compare that information against the configuration data for the given layer (e.g., the print-path(s)), and (iii) based on that comparison, determine whether the given layer has been deposited properly. In this respect, if there is a significant deviation between the deposited material for the given layer and the configuration data for the given layer, then the one or more computing units 240 may perform any of various remedial actions, examples of which may include alerting the user to such a deviation (e.g., via a notification that is presented on the touchscreen 130 or the client device 202), pausing the process of dispensing the material due to the deviation, and/or attempting to modify the dispensed material for the given layer in some way, among other possibilities.

Images captured by the camera could also be utilized in providing additional or alternative functionality. For example, the computing unit(s) 240 may transmit one or more images (or a series of images as a video) to the client device 202, such that a user may view the transmitted one or more images in order to (i) track progress (in real time) of the printing process for the 3D object and/or (ii) view any potential deviations that are detected via the one or more images and, perhaps, have been detected due to processing of the one or more images via one or more image processing techniques.

The camera, the images captured via the camera, and/or the functionality that utilizes the images captured via the camera may each take various other forms and may be utilized to provide various other functionalities, including but not limited to calibration operations for the example 3D printing system 200A.

As yet another possible variation and/or extension, the example 3D printing system 200A could be designed such that there is a mechanism for selectively opening or closing the flow path of a printing-process material from a given material canister 210 through a given feed line 216 to a given nozzle 218 that is included in addition or in alternative to the valve stem. For example, it is possible that the example 3D printing system 200A could include any one or more of (i) a mechanism for selectively opening or closing the orifice of the given material canister 210 through which the printing-process material is released into the feed line 216, (ii) a mechanism for selectively opening or closing the bottom end of the given feed line 216 through which the printing-process material is released into the given nozzle 218, and/or (iii) a mechanism for selectively opening or closing the top orifice of the given nozzle 218, among other possibilities.

As still a further possible variation and/or extension, the example 3D printing system 200A could be designed such that a given nozzle 218 is capable of receiving multiple printing-process materials of either the same type or different types from multiple different material canisters 210 via multiple different feed lines 216 that are connected to the given nozzle 218. In such an embodiment, the example 3D printing system 200A then also include a mechanism for controlling the flow of the multiple printing-process materials into the given nozzle 218 (e.g., respective valves that are located where the feed lines connect to the given nozzle 218 or perhaps further upstream) so that the example 3D printing system 200A can toggle which printing-process material is being fed into the given nozzle 218.

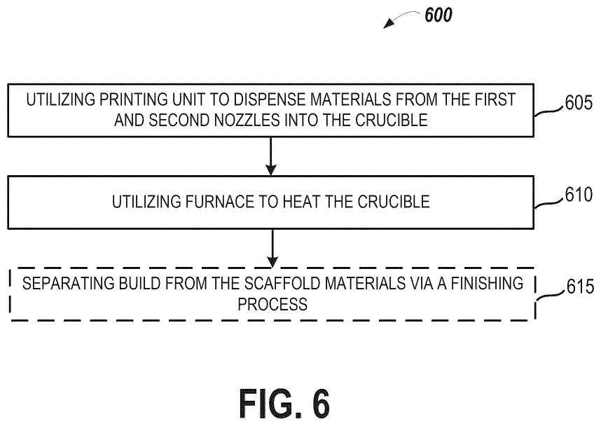

Turning now to FIG. 6, example functionality 600 that utilizes the disclosed 3D printing technology is illustrated in the form of a flow diagram. For purposes of illustration, the example functionality 600 of FIG. 6 is described as being carried out by the 3D printing system 100 disclosed herein, but it should be understood that the example functionality 600 of FIG. 6 may be carried out by another 3D printing system capable of carrying out the disclosed 3D printing technologies. Further, it should be understood that the example functionality of FIG. 6 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

As shown in FIG. 6, the example functionality 600 may begin at block 605 with utilizing the printing unit 220 to dispense the object materials 212 and the scaffold materials 214, respectfully, from the first and second nozzles 218A, 218B into the crucible 225. In line with the previous discussion, utilizing the printing unit 220 to dispense the object materials 212 and the scaffold materials 214 may involve controlling the printing unit 220 to dispense the object materials 212 and the scaffold materials 214, respectfully, from the first and second nozzles 218A, 218B into the crucible 225 on a layer-by-layer basis for a plurality of layers, wherein each respective layer of the plurality of layers comprises either or both of the object material 212 or the scaffold material 214. Further still, utilizing the printing unit 220 to dispense the object materials 212 and the scaffold materials 214 may involve one or both of: (i) controlling the printing unit 220 to dispense the object material 212 from the first nozzle 218A into the crucible 225 in accordance with a first print-path for dispensing the object material 212 within the respective layer and (ii) controlling the printing unit 220 to dispense the scaffold material 214 from the first nozzle 218B into the crucible 225 in accordance with a second print-path for dispensing the scaffold material 214 within the respective layer.

In a further example, utilizing the printing unit 220 to dispense the object materials 212 and the scaffold materials 214, respectfully, from the first and second nozzles 218A, 218B into the crucible 225 may further comprise one or both of (i) causing the object materials 212 to flow from the first canister 210A, through the first feed line 216A, and to the first nozzle 218A or (ii) causing the scaffold materials 214 to flow from the second canister 210B, through the second feed line 216B, and to the second nozzle 218B. In such examples, one or more vibrators 274 may be utilized to vibrate the first canister 210A, the first feed line 216A, and/or the first nozzle 218A and/or one or more vibrators may be utilized to vibrate the second canister 210B, the second feed line 216B, and/or the second nozzle 218B.

Utilizing the printing unit 220 to dispense the object materials 212 and the scaffold materials 214, respectfully, from the first and second nozzles 218A, 218B into the crucible 225 may take various other forms, as well.

At block 610, the 3D printing system 200 may utilize (or otherwise control) the furnace 230 to heat the crucible 225. Heating the crucible 225, utilizing the furnace 230, may take any of various forms, such as those disclosed herein.

At block 615, in an optional step, the disclosed 3D printing technology may involve, after the build comprising the sintered object material 212 and the scaffold material 214 has been cooled, separating the scaffold material 214 from the sintered object material 212 via a finishing process such as tumbling, media blasting, or the like. In this respect, the finishing process may take place within the 3D printing system 200 itself (e.g., a finishing mechanism that is integrated with the crucible 225 and/or furnace 230) or may take place within a separate machine (e.g., a tumbling or blasting machine), among other possibilities. During this finishing process, if the scaffold material 214 is of a type that has an abrasive texture as discussed above, then the scaffold material 214 may also serve to polish, smooth, debur, and/or clean the sintered object material 212, which may eliminate (or at least reduce) the need to separately perform these tasks either during or after the finishing process.

While the disclosed 3D printing technology is primarily described above in the context of creating objects out of an object material that comprises a type of metal material, the disclosed 3D printing technology may alternatively be utilized to create objects made from object materials that comprise other types of materials (e.g., plastic materials, organic materials, etc.).

For instance, as one alternative implementation, the disclosed 3D printing technology may be utilized to create a 3D object from object material that comprises a type of plastic. In such an alternative implementation, the first material canister 210A discussed above may contain a plastic material rather than a metal material, and the second material canister 210B may contain a scaffold material that has a higher sintering point than the plastic material. Given that plastic materials, generally, have a much lower sintering point than metal materials, it is contemplated that a scaffold material for use in creating objects from plastic materials may take similar form to the scaffold materials discussed above. However, due to the sintering point for plastic materials being, generally, much lower than sintering points for metal materials, scaffold materials for use with plastic materials may similarly have much lower sintering points than the scaffold materials for use with metal materials (so long as the scaffold materials'sintering point is higher than the sintering point of the plastic material).

As another alternative implementation, the disclosed 3D printing technology may be utilized to create a 3D object from object material that comprises a type of organic material. In such an alternative implementation, the first material canister 210A discussed above may contain an organic material rather than a metal material, and the second material canister 210B may contain a scaffold material that has a higher sintering point than the organic material. Given that many organic materials may have very low sintering points (even in comparison to plastic materials), this means that scaffold materials with similarly lower sintering points can be utilized as scaffold materials. Further, because sintering or otherwise fusing organic materials together to create an object of the organic materials may take other, lower-heat forms (in comparison to furnace-based sintering)-so long as a processing step that fuses the organic material does not fuse (or otherwise affect) the scaffold materials. Such processes (from which the scaffold material may be unaffected) may take various forms, such as, but not limited to, light sensitive fusing, heated-air fusing, etc.

The disclosed 3D printing technologies may, further, be utilized in creating objects out of various other materials that are used as the object material.

Turning now to FIG. 7, a simplified block diagram is provided to illustrate some structural components that may be included in an example computing unit 700 that may serve as one or more computing units of the disclosed 3D printing system (e.g., the one or more computing units 240 of FIGS. 2A, 2B). At a high level, the example computing unit 700 may generally comprise one or more processors 702, data storage 704, and one or more communication interfaces 706, each of which may be communicatively linked by a communication link 708 that may take the form of a system bus, a communication network such as a public, private, or hybrid cloud, or some other connection mechanism. Each of these components may take various forms.

For instance, the one or more processors 702 may comprise one or more processor components, such as one or more central processing units (CPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 702 could comprise processing components that are distributed across a plurality of physical computing devices connected via a network.

In turn, the data storage 704 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 704 may comprise computer-readable storage mediums that are distributed across a plurality of physical computing devices connected via a network.

As shown in FIG. 7, the data storage 704 may be capable of storing both (i) program instructions that are executable by the one or more processors 702 such that the example computing unit 700 is configured to perform any of the various functions disclosed herein (including but not limited to any of the device-control functions discussed above), and (ii) data that may be received, derived, or otherwise stored by the example computing unit 700.

The one or more communication interfaces 706 may comprise one or more interfaces that facilitate communication between the example computing unit 700 and other systems or devices (e.g., other computing unit(s) 700), where each such interface may be wired and/or wireless and may communicate according to any of various communication protocols. As examples, the one or more communication interfaces 706 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing unit 700 may additionally have an I/O interface that includes or provides connectivity to I/O components that facilitate user interaction with the example computing unit 700, such as a keyboard, a mouse, a trackpad, a display screen, a touch-sensitive interface, a stylus, a virtual-reality headset, and/or one or more speaker components, among other possibilities.

It should be understood that the example computing unit 700 is one example of a computing unit that may be used with the example 3D printing systems disclosed herein. Numerous other arrangements are possible and contemplated herein. For instance, in other examples, the example computing unit 700 may include additional components not pictured and/or more or less of the pictured components.

Turning next to FIG. 8, a simplified block diagram is provided to illustrate some structural components that may be included in an example client device 800 that may be configured to serve as the client device discussed above. At a high level, the example client device 800 may include one or more processors 802, data storage 804, one or more communication interfaces 806, and an I/O interface 808, each of which may be communicatively linked by a communication link 810 that may take the form a system bus and/or some other connection mechanism. Each of these components may take various forms.

For instance, the one or more processors 802 of the example client device 800 may comprise one or more processor components, such as one or more CPUs, GPUs, ASICs, DSPs, and/or programmable logic devices such as FPGAs, among other possible types of processing components.

In turn, the data storage 804 of the example client device 800 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 8, the data storage 804 may be capable of storing both (i) program instructions that are executable by the one or more processors 802 of the example client device 800 such that the example client device 800 is configured to perform any of the various functions disclosed herein (including but not limited to any of the client-side functions discussed above), and (ii) data that may be received, derived, or otherwise stored by the example client device 800.

The one or more communication interfaces 806 may comprise one or more interfaces that facilitate communication between the example client device 800 and other systems or devices, where each such interface may be wired and/or wireless and may communicate according to any of various communication protocols. As examples, the one or more communication interfaces 806 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 808 may generally take the form of (i) one or more input interfaces that are configured to receive and/or capture information at the example client device 800 and (ii) one or more output interfaces that are configured to output information from the example client device 800 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 808 may include or provide connectivity to output components such as a display screen and/or an audio speaker, among other possibilities.

It should be understood that the example client device 800 is one example of a client device that may be used with the examples described herein. Numerous other arrangements are possible and contemplated herein. For instance, in other examples, the example client device 800 may include additional components not pictured and/or more or fewer of the pictured components.

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

We claim:

1. A three-dimensional (3D) printing system comprising:
a printing unit that is adapted to hold, move, and actuate at least (i) a first nozzle that is connected via a first feed line to a first material canister containing a first type of material from which a 3D object is to be created and (ii) a second nozzle that is connected via a second feed line to a second material canister containing a second type of material that is to serve as a scaffold for the first type of material during creation of the 3D object;
a crucible;
a furnace; and
a computing system that is programmed to carry out functions comprising:
controlling the printing unit to dispense materials from the first and second nozzles into the crucible; and
controlling the furnace to heat the crucible.

2. The 3D printing system of claim 1, wherein the first type of material comprises a metal material and the second type of material comprises an inert material.

3. The 3D printing system of claim 1, wherein controlling the printing unit to dispense materials from the first and second nozzles into the crucible comprises:
controlling the printing unit to dispense materials from the first and second nozzles into the crucible on a layer-by-layer basis for a plurality of layers, wherein each respective layer of the plurality of layers comprises either or both of the first type of material or the second type of material.

4. The 3D printing system of claim 3, wherein controlling the printing unit to dispense materials from the first and second nozzles into the crucible on the layer-by-layer basis for the plurality of layers comprises, for each respective layer of the plurality of layers, one or both of:
controlling the printing unit to dispense the first type of material from the first nozzle into the crucible in accordance with a first print-path for dispensing the first type of material within the respective layer; or
controlling the printing unit to dispense the second type of material from the second nozzle into the crucible in accordance with a second print-path for dispensing the second type of material within the respective layer.

5. The 3D printing system of claim 1, wherein the printing unit comprises:
a carriage comprising:
a carriage body;
a first dispensing unit that is configured to hold and actuate the first nozzle;
a second dispensing unit that is configured to hold and actuate the second nozzle;
a first dispensing-motion unit that is configured to move the first dispensing unit in a vertical direction relative to the carriage body; and
a second dispensing-motion unit that is configured to move the second dispensing unit in the vertical direction relative to the carriage body; and
a carriage motion system that is configured to move the carriage in a horizontal plane.

6. The 3D printing system of claim 5, wherein:
the first dispensing unit comprises a first vibrator that is configured to vibrate the first nozzle; and
the second dispensing unit comprises a second vibrator that is configured to vibrate the second nozzle.

7. The 3D printing system of claim 6, further comprising
a third vibrator that is configured to vibrate the first material canister; and
a fourth vibrator that is configured to vibrate the second material canister.

8. The 3D printing system of claim 1, wherein the first and second nozzles each comprise:
an interior chamber that is fillable with the first or second type of material;
a bottom orifice for releasing the first or second type of material from the interior chamber; and
a valve stem that is movable within the interior chamber and operable to open or close the bottom orifice.

9. The 3D printing system of claim 1, wherein the computing system comprises:
a general-purpose computing unit; and
one or more specific-purpose computing units that are each communicatively coupled to the general-purpose computing unit.

10. The 3D printing system of claim 1, wherein:
the printing unit is further adapted to hold, move, and actuate one or more additional nozzles that are each connected via a respective feed line to a respective material canister; and
the computing system is further programmed to carry out functions comprising:
along with controlling the printing unit to dispense materials from the first nozzle and the second nozzle into the crucible, controlling the printing unit to dispense one or more materials from the one or more additional nozzles into the crucible.

11. The 3D printing system of claim 1, further comprising:
a camera that is operable to capture images of the crucible,
wherein the computing system is further programmed to carry out functions comprising:
using the images of the crucible captured by the camera as a basis for analyzing a state of the dispensed material within the crucible.

12. The 3D printing system of claim 1, wherein the second type of material has an abrasive texture that serves to polish, smooth, debur, or clean the 3D object during post-processing.

13. The 3D printing system of claim 1, wherein:
the first nozzle, the first feed line, and the first material canister are bonded together; and
the second nozzle, the second feed line, and the second material canister are bonded together.

14. A method carried out by a three-dimensional (3D) printing system comprising (i) a first material canister containing a first type of material from which a 3D object is to be created, (ii) a second material cannister containing a second type of material that is to serve as a scaffold for the first type of material during creation of the 3D object, (iii) a first feed line, (iv) a second feed line, (v) a first nozzle that is connected via the first feed line to the first material canister, (vi) a second nozzle that is connected via the second feed line to the second material canister, (vii) a printing unit that is adapted to hold, move, and actuate at least (a) the first nozzle and (b) the second nozzle, (viii) a crucible, (ix) a furnace, and (x) a computing system, the method comprising:
utilizing the printing unit to dispense materials from the first and second nozzles into the crucible; and
utilizing the furnace to heat the crucible.

15. The method of claim 14, wherein utilizing the printing unit to dispense materials from the first and second nozzles into the crucible comprises:
controlling the printing unit to dispense materials from the first and second nozzles into the crucible on a layer-by-layer basis for a plurality of layers, wherein each respective layer of the plurality of layers comprises either or both of the first type of material or the second type of material.

16. The method of claim 15, wherein controlling the printing unit to dispense materials from the first and second nozzles into the crucible on the layer-by-layer basis for the plurality of layers comprises, for each respective layer of the plurality of layers, one or both of:
controlling the printing unit to dispense the first type of material from the first nozzle into the crucible in accordance with a first print-path for dispensing the first type of material within the respective layer; or
controlling the printing unit to dispense the second type of material from the second nozzle into the crucible in accordance with a second print-path for dispensing the second type of material within the respective layer.

17. The method of claim 14, wherein utilizing the printing unit to dispense materials from the first and second nozzles into the crucible comprises:
causing the first materials to flow from the first canister, through the first feed line, and to the first nozzle; and
causing the second materials to flow from the second canister, through the second feed line, and to the second nozzle.

18. A three-dimensional (3D) printing system comprising:
a first material canister containing a first type of material from which a 3D object is to be created;
a second material canister containing a second type of material that is to serve as a scaffold for the first type of material during creation of the 3D object;
a first feed line;
a second feed line;
a first nozzle that (i) is connected via the first feed line to the first material canister and (ii) comprises:
a first interior chamber that is fillable with the first type of material;
a first bottom orifice for releasing the first type of material from the first interior chamber; and
a first valve stem that is movable within the first interior chamber and operable to open or close the first bottom orifice;
a second nozzle that (i) is connected via the second feed line to the second material canister and (ii) comprises:
a second interior chamber that is fillable with the second type of material;
a second bottom orifice for releasing the second type of material from the second interior chamber; and
a second valve stem that is movable within the second interior chamber and operable to open or close the second bottom orifice;
a printing unit comprising:
a carriage body;
a first dispensing unit that is configured to hold and actuate the first valve stem;
a second dispensing unit that is configured to hold and actuate the second valve stem;
a first dispensing-motion unit that is configured to move the first dispensing unit in a vertical direction relative to the carriage body; and
a second dispensing-motion unit that is configured to move the second dispensing unit in the vertical direction relative to the carriage body; and
a carriage motion system that is configured to move the carriage in a horizontal plane;
a crucible;
a furnace; and
a computing system that is programmed to carry out functions comprising:
controlling the printing unit to dispense materials from the first and second nozzles into the crucible on a layer-by-layer basis for a plurality of layers, wherein each respective layer of the plurality of layers comprises either or both of the first type of material or the second type of material; and
controlling the furnace to heat the crucible.

19. The 3D printing system of claim 18, wherein:
the first dispensing unit comprises a first vibrator that is configured to vibrate the first nozzle and thereby cause the first materials to flow from the first canister, through the first feed line, and to the first nozzle; and
the second dispensing unit comprises a second vibrator that is configured to vibrate the second nozzle and thereby cause the second materials to flow from the second canister, through the second feed line, and to the second nozzle.

20. The 3D printing system of claim 18, wherein:
the first nozzle, the first feed line, and the first material canister are bonded together; and
the second nozzle, the second feed line, and the second material canister are bonded together.
